(19) United States
(12) Patent Application Publication
(10) Pub. No.: US 2026/0106724 A1
(43) Pub. Date: Apr. 16, 2026

(54) Methods and Apparatus for PUSCH Transmission in non-SBFD and SBFD Slots

(71) Applicant: Charter Communications Operating, LLC, St. Louis, MO (US)

(72) Inventors: Mojtaba Ahmadi Almasi, Portland, OR (US); Dumitru M. Ionescu, Poway, CA (US); Maulik Vaidya, Escondido, CA (US)

(21) Appl. No.: 19/356,146

(22) Filed: Oct. 12, 2025

Related U.S. Application Data
(60) Provisional application No. 63/706,733, filed on Oct. 13, 2024.

(51) Int. Cl. H04L 5/14; H04W 72/0446; H04W 72/542; H04W 74/0833

(52) U.S. Cl. CPC H04L 5/14; H04W 72/0446; H04W 72/542; H04W 74/0833

(57) ABSTRACT

Methods and apparatus for supporting efficient PUSCH signaling in a communications system supporting Sub-band Full Duplex (SBFD) devices and non-SBFD devices and are described. A base station, which has successfully detected a PRACH signal including a Preamble from a UE, schedules PUSCH resources to be used by the UE to communicate a RRC setup request. In various embodiments, the type of slots or slots selected to be used for PUSCH transmissions, for a SBFD-aware, e.g., SBFD capable, UE is based on one or more of: resource availability, latency considerations, power considerations, and/or the likelihood of success for the PUSCH transmission if SBFD or non-SBFD resources are used. The base station generates and sends a random access response (RAR) message to the UE, communicating the base station selected PUSCH resource scheduling information indicating the resources to be used by the UE for PUSCH signaling.

### RELATED APPLICATIONS

The present application claims the benefit of U.S. Provisional Patent Application titled “Methods and Apparatus for PUSCH Transmission in non-SBFD and SBFD Slots as Part of initial Access” which was filed on Oct. 13, 2024 and assigned application Ser. No. 63/706,733 and which is hereby expressly incorporated by reference in its entirety.

### FIELD

The present application relates to communications methods and apparatus, and more particularly, to methods and apparatus for supporting physical uplink shared channel (PUSCH) transmission in non-SBFD symbols and slots and in SBFD symbols and slots.

### BACKGROUND

Sub-band full duplex (SBFD) is a recent form of full duplexing that enables the simultaneous transmission of uplink (UL) and downlink (DL) signals using non-overlapping frequency resources within the confines of the same unpaired time division duplexing (TDD) carrier. Support for SBFD and inclusion of SBFD slots in timing structures used for controlling communication systems is currently under discussion. While the introduction of SBFD slots, in which a portion of the slot is used for downlink communications and another, often smaller, portion of resources in the slot are used for uplink communications, has the potential to reduce the time between opportunities for a user equipment (UE) to attempt to access a network, it introduces complexities and needs for communicating control information to allow a UE to understand which portions of a SBFD are available to the UE for access attempts and/or other uplink communications while other portions of the same slot are being used for downlink signaling.

The introduction of UEs capable of using uplink transmission opportunities in SBFD slots introduces opportunities to reduce the time required to connect to a network, e.g., by reducing the time between random access opportunities, but also creates signaling and resource utilization issues associated with SBFD utilization. The issues are complicated by the fact that many networks will likely include some UEs or other devices which are not capable of utilizing SBFD slots and/or uplink resources in such slots because they predate or do not include support for using SBFD slots and/or uplink resources in such slots. Devices which are able to take advantage of the features and/or transmission opportunities provided by SBFD slots are sometimes referred to as SBFD aware devices.

In systems which support SBFD slots, timing structures used in the communication system can include a combination of Uplink only slots, sometimes referred to as Uplink slots, in which UEs can transmit uplink signals to base stations, e.g., gNBs, Downlink only slots, sometimes referred to as Downlink slots, and SBFD slots which can include a mix of Uplink and/or Downlink resources.

UEs or other devices which do not support the use of SBFD signaling or slots, e.g., because they predate or do not support such functionality, are referred to as non-SBFD devices or non-SBFD aware devices. Accordingly, a non-SBFD aware device is a device which cannot take advantage of features made possible by SBFD functionality.

Before a UE can communicate via a network it must perform what is sometimes referred to as an initial access. Initial access is performed before data communication occurs with the UE trying to connect to a network via a base station, e.g., gNB. When performing an initial access, a UE does not know which gNB it is trying to connect to. To establish the connection, UE and gNB follow an initial access procedure.

A common initial access procedure includes two main steps: a cell search step and a random access step. During cell search, a UE receives necessary information about the gNB that it wants to connect to along with synchronization signals and information about random access channel.

After receiving information about the random access channel, a UE will normally proceed with a random access procedure. The random access procedure typically includes transmission of a signal, by the UE on Physical Random Access Channel (PRACH) resources. With the case of a legacy (non-SBFD aware) UE, the legacy UE is restricted to using PRACH resources only on non-SBFD slots. However, with the case of a SBFD-aware UE, PRACH resources may be available to be selected and used on both non-SBFD slots and SBFD slots.

Following reception of a PRACH signal including a Preamble from a UE, the base station will schedule PUSCH resources for the UE via a random access response (RAR) message. With the case of a legacy (non-SBFD aware) UE, the legacy UE is restricted to using PUSCH resources only on non-SBFD slots. However, with the case of a SBFD-aware UE, PUSCH resources may be available to be selected and used on both non-SBFD slots and SBFD slots.

Based on the above discussion, there is a need for new methods and apparatus to support PUSCH transmission attempts in an environment, in which SBFD slots include resources, e.g., symbols corresponding to PUSCH occasions (POs), which are available to be used for PUSCH by SBFD-aware UEs, in addition to the available resources in non-SBFD slots. It would be beneficial if at least some of these new methods and apparatus facilitated the base station selection and scheduling, for SBFD-aware UEs, of PUSCH resources, which are likely to provide more efficient communications including a higher communication attempt success rate and/or provide for lower latency. It would be beneficial if at least some of these new methods and apparatus were implemented without negatively impacting legacy UE access operations including base station scheduling of PUSCH for legacy UEs and legacy UE PUSCH communications.

### SUMMARY

Methods and apparatus for supporting efficient PUSCH signaling in a communications system supporting Sub-band Full Duplex (SBFD) devices and non-SBFD devices and are described. A base station, which has successfully detected a PRACH signal including a Preamble from a UE, schedules PUSCH resources to be used by the UE to communicate a RRC setup request.

A timing-frequency structure is implemented by a base station, e.g., gNB, which includes both non-SBFD slots and SBFD slots. Time-Frequency resources, which may be used for communicating PUSCH transmissions, are included in both non-SBFD slots and SBFD slots. Non-SBFD aware UEs, e.g., legacy UEs, are restricted to using non-SBFD slots for the PRACH transmissions and PUSCH transmissions; however, SBFD-aware UEs are not. If the base station is aware that a UE is a SBFD-aware UE, e.g., based on RACH signal received in a SFBD slot, the base station may, and sometimes does, schedule PUSCH transmission for the SBFD-aware UE on SBFD-slot resources. Base stations are generally allowed to schedule identified SBFD-aware UEs to use time-frequency resources corresponding to both non-SFBD slots and SBFD slots for PUSCH transmissions, but may be, and sometimes are, subject to restrictions and/or rules, which may determine which type of slot or slots to use, e.g., only SBFD slots, only non-SBFD slots, or a combination of non-SBFD slots and SBFD slots. In various embodiments, the type of slots or slots selected to be used for PUSCH transmissions, for a SBFD-aware UE, is based on one or more of: resource availability, latency considerations, power considerations, and/or the likelihood of success for the PUSCH transmission. The base station generates and sends a random access response (RAR) message to the UE, communicating the base station selected PUSCH resource scheduling information.

In various embodiments, if the base station does not receive the expected PUSCH signal, the base station may, and sometimes does, determine, e.g., select, resources to be used for PUSCH re-transmission based on type(s) of slot(s) used for the initial PUSCH transmission attempt. In some embodiments, the base station determines, e.g., calculates, the power level to be used for PUSCH re-transmission and/or a number of PUSCH re-transmissions based on the power level used for the initial PUSCH transmission attempt and/or the number of repetitions in the initial PUSCH transmission attempt. The base station generates and sends a downlink control information (DCI) message to the UE, communicating information identifying the scheduled resources for PUSCH re-transmission and other PUSCH re-transmission related information, e.g. transmit power level and number of repetitions.

An exemplary method of operating a base station, in accordance with some embodiments, comprises: receiving a PRACH signal on SBFD slot resources from a first UE; selecting resources to be used by the first UE for PUSCH signaling by selecting between use of SBFD resources and non-SBFD resources based on at least one of: i) resource availability, ii) latency, iii) a transmit power level to be used for UE PUSCH transmission by the first UE, or iv) the resource type of a received signal whose power is used to control the transmit power level to be used for UE PUSCH transmission by the first UE; and transmitting a random access response (RAR) message to the first UE indicating PUSCH resources allocated to the first UE for PUSCH signaling, said resources being said selected resources to be used by the first UE for PUSCH signaling.

An method of operating a base station, in accordance with some embodiments, comprises: receiving a PRACH signal from a first UE; sending a random access response (RAR) message to the first UE indicating resources to be used by the first UE for transmitting a PUSCH signal, said resources being first type of resource, said first type of resource being one of i) a SBFD resource or ii) a non-SBFD resource; failing to detect a PUSCH signal from the first UE on the indicated resources to be used by the first UE for transmitting a PUSCH signal; scheduling PUSCH re-transmission for the first UE on resources which are of a different type than the first type resources; and sending PUSCH re-transmission scheduling information to the first UE.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in accordance with an exemplary embodiment of the invention.

FIG. 2 is a drawing of an exemplary base station, e.g., a gNB, in accordance with an exemplary embodiment of the invention.

FIG. 3 is a drawing of an exemplary user equipment (UE), e.g., a SBFD-aware UE, in accordance with an exemplary embodiment of the invention.

FIG. 4 is a drawing of an exemplary user equipment (UE), e.g., a legacy UE which is a non SBFD-aware UE, in accordance with an exemplary embodiment of the invention.

FIG. 5 is a signaling diagram illustrating a 4-step RACH access method, being performed between exemplary base station, e.g., a gNB, and exemplary SBFD-aware UE, in accordance with an exemplary embodiment.

FIG. 6A is a first part of a flowchart of an exemplary communications method including PRACH and PUSCH transmission in a 4 step access, e.g., a 4-step initial access, in accordance with an exemplary embodiment.

FIG. 6B is a second part of a flowchart of an exemplary communications method including PRACH and PUSCH transmission in a 4 step access, e.g., a 4-step initial access, in accordance with an exemplary embodiment.

FIG. 6 is a drawing illustrating how FIG. 6A and FIG. 6 are combined to form FIG. 6.

FIG. 7 is a drawing illustrating an example, in which a PUSCH transmission for a SBFD-aware UE is scheduled, by a base station, to be in non-SBFD slot(s) of a timing-frequency structure including SBFD slots and non-SBFD slots, following transmission of PRACH signal by the UE in a non-SBFD slot, in accordance with an exemplary embodiment.

FIG. 8 is a drawing illustrating an example, in which PUSCH transmission(s) for a SBFD-aware UE is scheduled, by a base station, to be in SBFD and non-SBFD slot(s) of a timing-frequency structure including SBFD slots and non-SBFD slots, following transmission PRACH signal(s) by the UE in a SBFD slot(s), in accordance with an exemplary embodiment.

FIG. 9 is a drawing illustrating an example, in which PUSCH transmission(s) for a SBFD-aware UE is scheduled, by a base station, to be in only SBFD slot(s) of a timing-frequency structure including SBFD slots and non-SBFD slots, following transmission of PRACH signal(s) by the UE in a SBFD slot(s), in accordance with an exemplary embodiment.

FIG. 10 is a flowchart of an exemplary communications method including PUSCH transmission repetitions, in accordance with an exemplary embodiment.

FIG. 11 is a drawing illustrating an example of a PUSCH repetition type A, in which PUSCH transmission is repeated in only non-SBFDs slots of a timing-frequency structure including SBFD slots and non-SBFD slots.

FIG. 12 is a drawing illustrating an example of a PUSCH repetition type A, in which PUSCH transmission is repeated in only SBFDs slots of a timing-frequency structure including SBFD slots and non-SBFD slots.

FIG. 13 is a drawing 1300 illustrating an example of a PUSCH repetition type A, in which PUSCH transmission is across non-SBFDs slots and SBFD slots of a timing-frequency structure including SBFD slots and non-SBFD slots.

FIG. 14 is a signaling diagram illustrating a 4-step RACH access method, being performed between exemplary base station, e.g., a gNB, and exemplary SBFD-aware UE, which illustrates an example, in which a first msg3 PUSCH signal is detected successfully by the base station.

FIG. 15 is a signaling diagram illustrating a 4-step RACH access method, being performed between exemplary base station, e.g., a gNB, and exemplary SBFD-aware UE, which illustrate an example, in which a first msg3 PUSCH signal fails, and the base station schedules msg3 PUSCH re-transmission via DCI, and the msg3 PUSCH re-transmission is detected successfully by the base station.

FIG. 16A is a first part of a flowchart of an exemplary communications method in accordance with an exemplary embodiment, said exemplary method including scheduling PUSCH resources for a PUSCH re-transmission for a SBFD-aware UE, following failure of a base station to successfully detect a first PUSCH signal.

FIG. 16B is a second part of a flowchart of an exemplary communications method in accordance with an exemplary embodiment, said exemplary method including scheduling PUSCH resources for a PUSCH re-transmission for a SBFD-aware UE, following failure of a base station to successfully detect a first PUSCH signal.

FIG. 16 comprises the combination of FIG. 16A and FIG. 16B.

### DETAILED DESCRIPTION

Various features of the invention relate to what are sometimes referred to as MSG3-PUSCH and MSGA-PUSCH transmission, which, in the case of various embodiments of the invention, can occur in SBFD and/or non-SBFD slots. In this context PUSCH stands for Physical Uplink Shared Channel.

To this end, various transmission methods and aspects of the invention relate to one or more of: Physical Random Access Channel (PRACH) and/or PUSCH transmission in Sub-band full duplex (SBFD) and/or non-SBFD slots, PUSCH repetition, PUSCH intra-slot and inter-slot frequency hopping, PUSCH transmission and retransmission, and PUSCH occasion in 2-step initial random access (RA).

Before going through the details of various embodiments and features of the invention, some terminology will first be explained.

There are normally 14 OFDM symbols per slot in various embodiments.

In an Uplink (UL) slot: all the OFDM symbols in time domain and all the resource blocks (RBs) in frequency domain are allocated for UL direction.

In a Downlink (DL) slot all the OFDM symbols in time domain and all the resource blocks (RBs) in frequency domain are allocated for DL direction.

In an UL symbol: all the Resource Blocks (RBs) are allocated for UL direction and there is only one OFDM symbol in time domain.

In a DL symbol: all the RBs are allocated for DL direction and there is only one OFDM symbol in time domain.

A sub-band full duplex (SBFD) slot is a slot used for downlink (DL), but in the OFDM symbols within the SBFD slot some of the RBs (e.g., 20% of the RBs) are allocated for UL transmission. Thus, an SBFD slot and/or SB symbol can support some uplink transmission but normally far less than an UL slot.

SBFD symbol: This is a symbol that occupies one OFDM symbol, but some of the RBs are allocated for UL transmission with others allocated for DL transmission.

A non-SBFD slot and/or symbol is a slot or symbol where the RBs are allocated for UL or DL transmissions but not both UL and DL in the same slot/symbol.

Before a UE transmits/receives data or control signaling from a gNB, the UE will perform an initial access using an access channel. The channel which is used to perform the initial access is referred to as an initial random access channel (RACH). There are two different RACH methods, which can be used, with one method being a 4 step method and the other method being a 2-step method. The particular steps depend on the mode in which the UE is operating when attempting a RACH procedure. Accordingly, there is a 4-step contention-based random access (CBRA) and a 2-step CBRA for use when UE is in idle mode. Also, there is 4-step contention-free random access (CFRA) and 2-step CFRA, which can be used by a UE when the UE is in RRC-connected mode.

Before a User Equipment (UE) transmits and/or receives data or control signaling from a base station, e.g., a gNB, the UE normally accesses a channel which is called initial random access channel (RACH). There are two different RACH methods: 4-step contention-based random access (CBRA) and 2-step CBRA when UE is in idle mode. Also, there are 4-step contention-free random access (CFRA) and 2-step CFRA which are used when UE is in RRC-connected mode.

This invention focuses on 4-step and 2-step CBRA, although one or more of the proposed SSB-RO mappings can be applied to other random access methods.

The 4 steps in the 4-step initial RA are as follows:
MSG1—UE transmits a PRACH signal toward gNB. The signal is a Zadoff-Chu sequence constructed from a preamble. To transmit the PRACH, UE needs to finds proper RO. This is done through Synchronization Signal Block—RACH Occasion (SSB-RO) mapping obtained from the Synchronization Signal Block/Physical Broadcast Channel (SSB/PBCH) and System Information Block 1 (SIB1) signaling before message 1 (MSG1).
MSG2—gNB detects the PRACH and preamble. Then, the gNB sends a Downlink Control Information (DCI) and Physical Downlink Shared Channel (PDSCH). The Cyclic Redundancy Check (CRC) in the DCI is scrambled by Radio Access—Radio Network Temporary Identifier (RA-RNTI), which is obtained from RACH Occasion's (RO's) time and frequency information. The Physical Downlink Shared Channel (PDSCH), contains UL grant, TC-RNTI, etc.
MSG3—UE transmits its ID scrambled by Temporary Cell-Radio Network Temporary Identifier (TC-RNTI).
MSG4—gNB sends a DCI and PDSCH. The PDSCH verifies that gNB has received the MSG3.

Finally, UE transmits Hybrid Automatic Repeat Request—Acknowledgment (HARQ-ACK) through Physical Uplink Control Channel (PUCCH) to inform gNB that the UE has received the MSG4.

In the 2-step initial Random Access (RA), step-1 includes MSG-A which is combination of MSG1 and MSG3. Step-2 includes MSG-B which is mainly similar to MSG-4 in the 4-step.

In legacy SSB-RO mappings (e.g., mappings which do not include SBFD slots), ROs are located in non-SBFD symbols (only UL symbols/slots). In order to reduce latency and/or PRACH collision, it is likely that in the next version of one or more communications standards (e.g., in a future 3GPP release 19 which has not yet been agreed upon), SBFD symbols/slots will be allowed to be allocated for random access. However, the inventors of the present application realize that frequency resources (i.e., RBs) and/or the time duration (i.e., OFDM symbols) in SBFD symbols/slots could be different from that of the non-SBFD symbols. For instance, the number of RBs in SBFD symbols is usually limited to 50 RBs. However, in a non-SBFD symbol (i.e., an UL symbol), the number of RBs allocated for RACH Occasions (ROs) and PUSCH occasions (POs) can be up to 96 RBs. Also, the starting RBs in SBFD and non-SBFD symbols are different. To deal with and/or take advantage of the differences, various features and embodiments of the invention accommodate PUSCH signal transmission in 4-step and 2-step initial RA procedure.

In accordance with a first aspect, in some embodiments, PRACH and PUSCH transmission, when both SBFD and non-SBFD (legacy) slots are deployed, is addressed in 4-step initial RA procedure. In such a case one or more of three different options are supported in accordance with the invention: 1) PRACH and PUSCH are transmitted only in non-SBFD slots, 2) PRACH and PUSCH are transmitted only in SBFD slots, 3) PRACH on non-SBFD slots and PUSCH on SBFD slots and vice versa. The first two options have the advantage of reducing or avoiding, e.g., gNB and UE extra overhead signaling and some additional adjustments that might be required if other approaches/options were used. The third option has the advantage of potentially reduced latency and provides more occasions for an SBFD-aware UE.

In accordance with a second aspect, PUSCH Repetition Type A, when both SBFD and non-SBFD (legacy) slots are deployed, is supported. One, more or all of the three different options are considered and possible in accordance with the invention: 1) PUSCH repetitions occupying more than one slot can be transmitted only in non-SBFD slots, 2) PUSCH repetitions occupying more than one slot can be transmitted only in SBFD slots, and 3) PUSCH repetitions occupying more than one slot can be transmitted across non-SBFD and SBFD slots. One more or all of these options can be supported depending on UE capability and/or the timing structure being used.

In accordance with a third aspect of the invention, frequency hopping for PUSCH repetition Type A in SBFD slots (i.e., in addition to PUSCH repetition in non-SBFD slots in prior releases) is addressed. One or more of the supported options include the following two options: 1) Intra-slot frequency hopping, and 2) Inter-slot frequency hopping. In both options, the same equation from the previous releases of the 3GPP can be used. Depending on the embodiments parameters such as Resource Block (RB) offset can be same in SBFD slots and non-SBFD slots or can be configured separately, e.g., be different. In some embodiments the same table is used for RB offset determination regardless of using the same RB offset or separate RB offset for SBFD and non-SBFD slots. Other parameters such as starting RB can be same or configured separately depending on the embodiment.

A fourth aspect of the invention relates to a similar topic to aspect 1 but with the described approach/features being used in the 2-step initial access procedure.

In a fifth aspect of the invention, first PUSCH transmission and PUSCH retransmission, when both SBFD and non-SBFD (legacy) slots are deployed, is addressed. One or more of three options are supported with regard to this aspect: 1) the first PUSCH and the retransmission happens only in non-SBFD slots, 2) the first PUSCH and the retransmission happens only in SBFD slots, and 3) PUSCH transmission happens in non-SBFD slots and PUSCH retransmission happens in SBFD slots and vice versa.

In accordance with a sixth aspect of the invention, PUSCH Occasion resource configuration in 2-step initial RA, when both SBFD and non-SBFD (legacy) slots are deployed, is addressed. With regard to this aspect one or more of the following two options are supported: 1) Same MSGA-PUSCH-Resource-r16 configuration for PUSCH occasions in both SBFD and non-SBFD slots, and 2) Configure Separate MSGA-PUSCH-Resource-r19 Information Element (IE) explicitly specifying PUSCH occasions in (non-)SBFD slots.

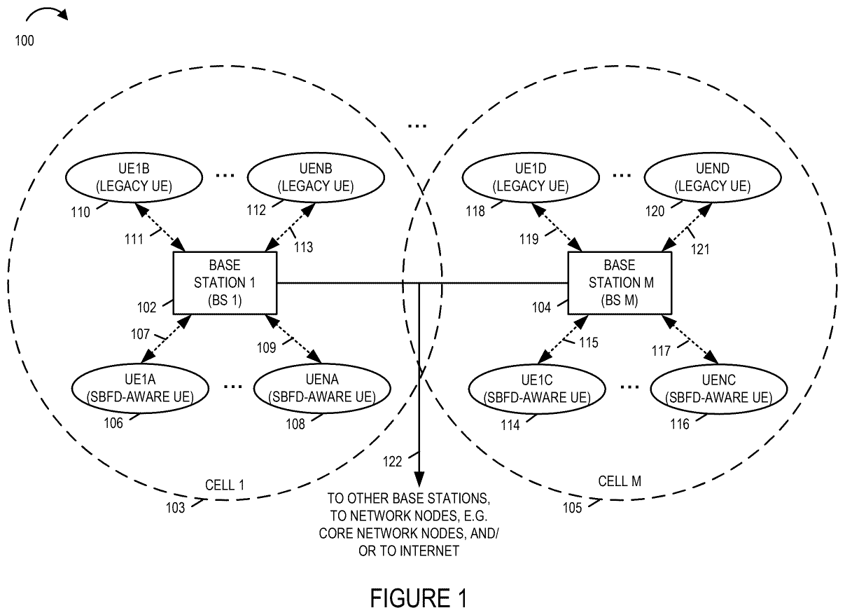

FIG. 1 is a drawing of an exemplary communications system 100 in accordance with an exemplary embodiment of the invention. Exemplary communications system 100 includes a plurality of base stations (base station 1 102, . . . , base station M 104) coupled together, to network nodes, e.g., to 5G core network nodes, and/or to the Internet via communications backhaul link(s) 122. Exemplary communications system 100 further includes a plurality of user equipments (UEs) (UE1A 106, . . . , UENA 108, UE1B 1010, . . . , UENB 112, UE1C 114, . . . , UENC 116, UE1D 118, . . . , UEND 120). At least some of the UEs are mobile wireless devices which may move throughout system 100 and be connected to different base stations at different time. Some of the UEs are SBFD-aware UEs, while other UEs are legacy UEs. UE1A 106, UENA 108, UE1C 114, and UENC 116 are SBFD-aware UEs. UE1B 110, UENB 102, UE1D 118, and UEND 120 are legacy UEs.

Base station 1 (BS 1) 102 has a corresponding cellular coverage area 103. UEs (106, 108, 110 and 112 are currently located within cellular coverage area 103. UE1A 106 is coupled to BS 1 102 via wireless connection 107. UENA 108 is coupled to BS 1 102 via wireless connection 109. UE1B 110 is coupled to BS 1 102 via wireless connection 111. UENB 112 is coupled to BS 1 102 via wireless connection 113.

Base station M (BS M) 104 has a corresponding cellular coverage area 105. UEs (114, 116, 118 and 120 are currently located within cellular coverage area 105. UE1C 114 is coupled to BS M 104 via wireless connection 115. UENC 116 is coupled to BS M 104 via wireless connection 117. UE1D 118 is coupled to BS M 104 via wireless connection 119. UEND 120 is coupled to BS M 104 via wireless connection 121.

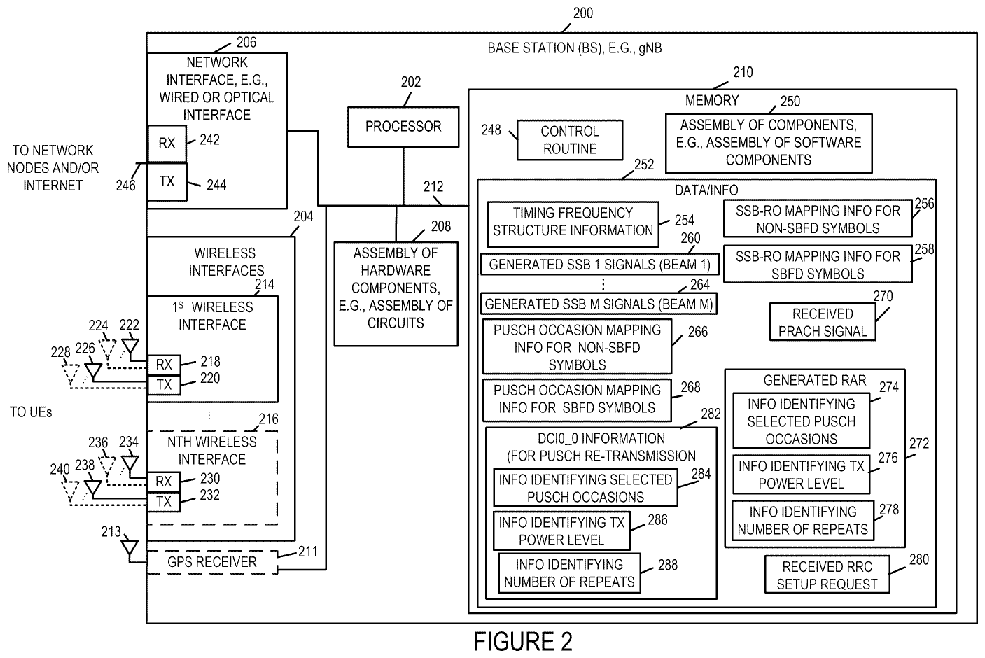

FIG. 2 is a drawing of an exemplary base station 200, e.g., a gNB, in accordance with an exemplary embodiment. Exemplary base station 200 is, e.g., BS 1 1202 or BS M 1204 of system 1200 of FIG. 1. Exemplary base station 200 includes a processor 202, e.g., a CPU, wireless interfaces 204, a network interface 206, an assembly of hardware components 208, e.g., an assembly of circuits, and memory 210 coupled together via bus 212 over which the various elements may interchange data and information. In some embodiments, base station 200 further includes a GPS receiver 211 coupled to bus 212.

Wireless interfaces 204 includes one or more wireless interfaces (1st wireless interface 214, . . . , Nth wireless interface 216). 1st wireless interface 214 includes wireless receiver 218 and wireless transmitter 220. Wireless receiver 218 is coupled to one or more receiver antennas (222, . . . , 224) via which the base station 200 receives wireless uplink signals from UEs. Wireless transmitter 220 is coupled to one or more transmit antennas (226, . . . , 228) via which the base station 200 transmits wireless downlink signals to UEs. In some embodiments one or more antennas are used by both the receiver 218 and transmitter 220. Nth wireless interface 216 includes wireless receiver 230 and wireless transmitter 232. Wireless receiver 230 is coupled to one or more receive antennas (234, . . . , 236) via which the base station 200 receives wireless uplink signals from UEs. Wireless transmitter 232 is coupled to one or more transmit antennas (238, . . . , 240) via which the base station 200 transmits wireless downlink signals to UEs. In some embodiments one or more antennas are used by both the receiver 230 and transmitter 232. In some embodiments different wireless interfaces correspond to different communications bands, different spectrum, and/or different communications protocols.

Network interface 206, e.g., a wired or optical interface, includes receiver 242, transmitter 244 and connector 246. Network interface 206 couples the base station 200 to network nodes, e.g., other base stations, core network nodes, e.g., 5G core network nodes, and/or the Internet.

GPS receiver 211 is coupled to GPS receive antenna 213. GPS signals, received via GPS receive antenna 213, are processed by the GPS receiver 211 to determine time, position, e.g. latitude, longitude and altitude, and velocity information. In some embodiment the GPS receiver 211 is used to facilitate a precise placement of the base station 200, e.g., as part of an installation process.

Memory 210 includes a control routine 248, an assembly of components 250 and data/information 252. Control routine 248 includes instructions which when executed by processor 202 control the base station 200 to implement basic operational functions, e.g., read memory, write to memory, control an interface, load a program, subroutine, or app, etc. Assembly of components 250, e.g., an assembly of software components, e.g., routines, subroutines, applications, etc., includes, e.g., code, e.g., machine executable instructions, which when executed by processor 202, controls the base station 200 to implement steps of a method in accordance with the present invention. Data/information 252 includes timing-frequency structure information 254, said timing-frequency structure, being implemented by base station 200 includes non-SBFD slots, each non-SBFD slot including one or more non-SBFD symbols and SBFD slots, each SBFD slot including one or more SBFD symbols. Data/information 252 includes timing-frequency structure information 254, SSB-RO mapping information for non-SBFD symbols 256, SSB-RO mapping information for SBFD symbols 258 and generated Synchronization Signal Block (SSB) signals for a plurality of beams (generated SSB 1 signals 260 corresponding to beam 1, . . . , generated SSB M signals 262 corresponding to beam M).

In various embodiments, in accordance with the present invention, there is a different SSB-RO mapping for non-SBFD symbols and SBFD symbols. Thus, in some embodiments, SSB-RO mapping information for non-SBFD symbols 256 is different from SSB-RO mapping information for SBFD symbols 258 information. Four exemplary different cases are possible in which different SSB-RO mapping is used for non-SBFD symbols and SBFD symbols. In a first case, with regard to the SSO-RO mapping, the same periodicity is used, the same number of SSBs per RO, and the same PRACH duration is used for both non-SBFD symbols and SBFD symbols. In a second case, with regard to the SSO-RO mapping, the same periodicity is used and the same PRACH format is used for both non-SBFD symbols and SBFD symbols, but there are different number of SSBs per RO depending upon whether it is a non-SBFD symbol or a SBFD symbol. In a third case, with regard to the SSO-RO mapping, the same periodicity is used and there is the same number of SSBs per RO for both non-SBFD symbols and SBFD symbols, but there is different PRACH duration/format depending upon whether it is a non-SBFD symbol or a SBFD symbol. In a fourth case, with regard to the SSO-RO mapping, there is the same number of SSBs per RO and the same PRACH duration for both non-SBFD symbols and SBFD symbols, but there is different periodicity depending upon whether it is a non-SBFD symbol or a SBFD symbol.

Data/information 252 further includes PUSCH occasion (PO) mapping information for non-SBFD symbols 266, PUSCH occasion mapping information for SBDS symbols 268, a generated random access response (RAR) message 272 including information 274 identifying PUSCH occasions, information 276 identifying PUSCH signal transmission power level and information 278 identifying number of PUSCH signal repeats, and a received radio resource control (RRC) setup request message 280. Data/information 252 further includes Downlink control information DCI0_0 282 including information 284 identifying PUSCH occasions to be used for re-transmission of PUSCH signals, information 286 identifying PUSCH signal transmission power level to be used for re-transmission of PUSCH signals, and information 288 identifying number of PUSCH signal repeats to be used for re-transmission of PUSCH signals.

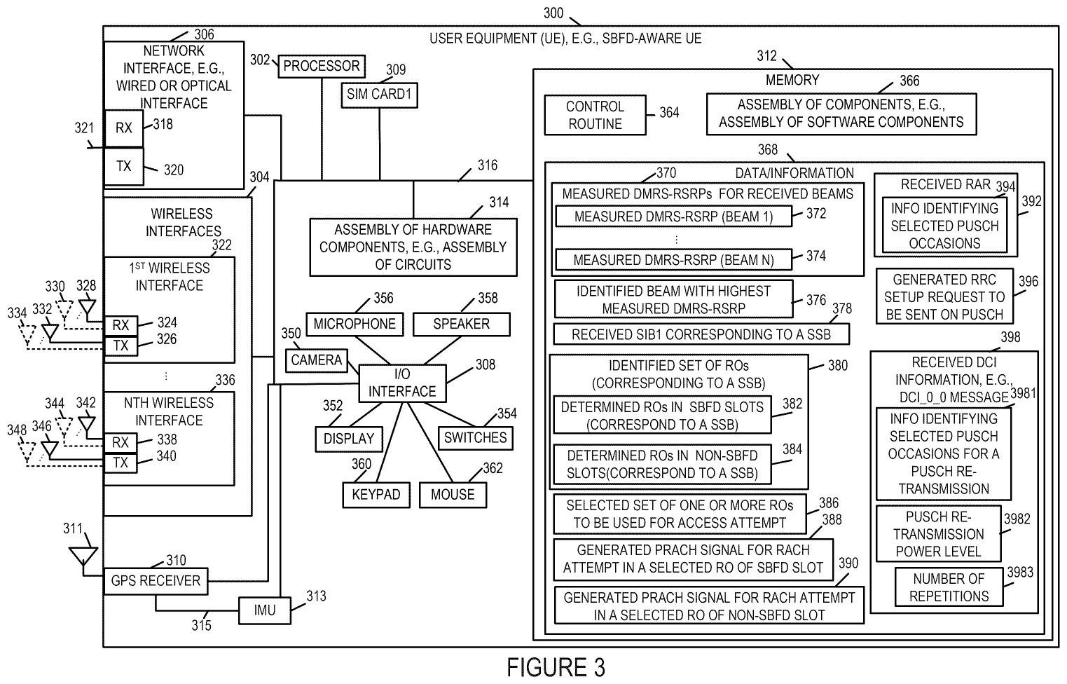

FIG. 3 is a drawing of an exemplary user equipment (UE) 300, e.g., a SBFD-aware UE, in accordance with an exemplary embodiment. An SBFD-aware UE is sometimes referred to as an SBFD-capable UE or an SBFD-enabled UE. Exemplary UE 300 of FIG. 3 is, e.g., any of UEs (106, 108, 114, 116) of system 100 of FIG. 1.

Exemplary UE 300 includes a processor 302, e.g., a CPU, wireless interfaces 304, a network interface 306, e.g., a wired or optical interface, I/O interface 308, GPS receiver 310, inertial measurement unit (IMU) 313, and assembly of hardware components 314, e.g., an assembly of circuits, coupled together via bus 316 over which the various elements may interchange data and information. In various embodiments, UE 300 further includes SIM card 1 309 coupled to bus 316.

Wireless interfaces 304 includes a plurality of wireless interfaces (1st wireless interface 322, . . . , Nth wireless interface 336). 1st wireless interface 322 includes wireless receiver 324 and wireless transmitter 326. Wireless receiver 324 is coupled to one or more receiver antennas (328, . . . , 330) via which the UE 300 receives wireless downlink signals from base stations. Wireless transmitter 326 is coupled to one or more transmit antennas (332, . . . , 334) via which the UE 300 transmits wireless uplink signals to base stations. In some embodiments one or more antennas are used by both the receiver 324 and transmitter 326. Nth wireless interface 336 includes wireless receiver 338 and wireless transmitter 340. Wireless receiver 338 is coupled to one or more receive antennas (342, . . . , 344) via which the UE 300 receives wireless downlink signals from base stations. Wireless transmitter 340 is coupled to one or more transmit antennas (346, . . . , 348) via which the UE 300 transmits wireless uplink signals to base stations. In some embodiments one or more antennas are used by both the receiver 338 and transmitter 340. In some embodiments different wireless interfaces correspond to different communications bands, different spectrum, and/or different communications protocols.

Network interface 306, e.g., a wired or optical interface, includes receiver 318, transmitter 320 and connector 321. Network interface 306 may, and sometimes does, couple UE 300 to base stations, network nodes and/or the Internet, e.g., when the UE 300 is stationary and located at a site with a wireline and/or optical connection.

GPS receiver 310 is coupled to GPS antenna 311. GPS receiver 310 is further coupled to IMU 313, e.g., an IMU on a chip including gyroscopes and accelerometers. GPS signals, received via GPS receive antenna 311, are processed by the GPS receiver 310 to determine time, position, e.g. latitude, longitude and altitude, and velocity information of UE 300. In some embodiments, information from IMU 313, e.g., accelerometer and/or gyroscopes measurements over time, are used, in conjunction with or in place of GPS measurements to determine position, e.g. latitude, longitude and altitude, and velocity information of UE 300. SIM card 1 309 includes information corresponding to a first communications network operator to which the owner of UE 300 is a subscriber.

UE 300 further includes a plurality of I/O devices (camera 350, display 352, e.g., a touch screen display, switches 354, microphone 356, speaker 358, keypad 360 and mouse 362) coupled to I/O interface 308, which couples the various I/O devices to other elements of the UE 300 via bus 316.

Memory 312 includes a control routine 364, an assembly of components 366, e.g., an assembly of software components, and data/information 368. Control routine 364 includes instructions which when executed by processor 302 control the UE 300 to implement basic operational functions, e.g., read memory, write to memory, control an interface, load a program, subroutine, or app, etc. Assembly of components 366, e.g., an assembly of software components, e.g., routines, subroutines, applications, etc., includes, e.g., code, e.g., machine executable instructions, which when executed by processor 302, controls the UE 300 to implement steps of a method in accordance with an exemplary embodiment of the present invention.

Data/information 368 includes measured DMRS-RSRPs for received beams 370 (a measured DMRS-RSRP corresponding to beam 1 372, . . . , a measured DMRS-RSRP corresponding to beam N 374), an identified beam with the highest measured DMRS-RSRP 376, a received SIB1 corresponding to a SSB 378, an identified set of ROs (corresponding to a SSSB) 380 including determined ROs (corresponding to the SSB) in SBFD slots 382 and determined ROs (corresponding to the SSB) in non-SBFD slots 384, a selected set of one or more ROs to be sued for an access attempt, a generated PRACH signal for a RACH attempt in a selected RO of a SBFD slot 388, a generated PRACH signal for a RACH attempt in a selected RO of a non-SBFD slot 390, a received RAR 392 including information 394 identifying base station selected (scheduled) PUSCH occasion(s) 394 to be used by the UE, and a generated RRC setup request message 396 to be sent on scheduled PUSCH resources, e.g., as part of a first PUSCH transmission attempt or as part of a PUSCH re-transmission attempt. Data/information 368 further includes received DCI information 398, e.g., a received DCI_0_0 message, including information 2981 identifying base station selected PUSCH occasions to be used by UE 300 for a PUSCH re-transmission attempt, information 3982 communicating a PUSCH signal re-transmission power level 3982, and information 3983 communicating a number of PUSCH repetitions to be performed as part of the PUSCH re-transmission attempt.

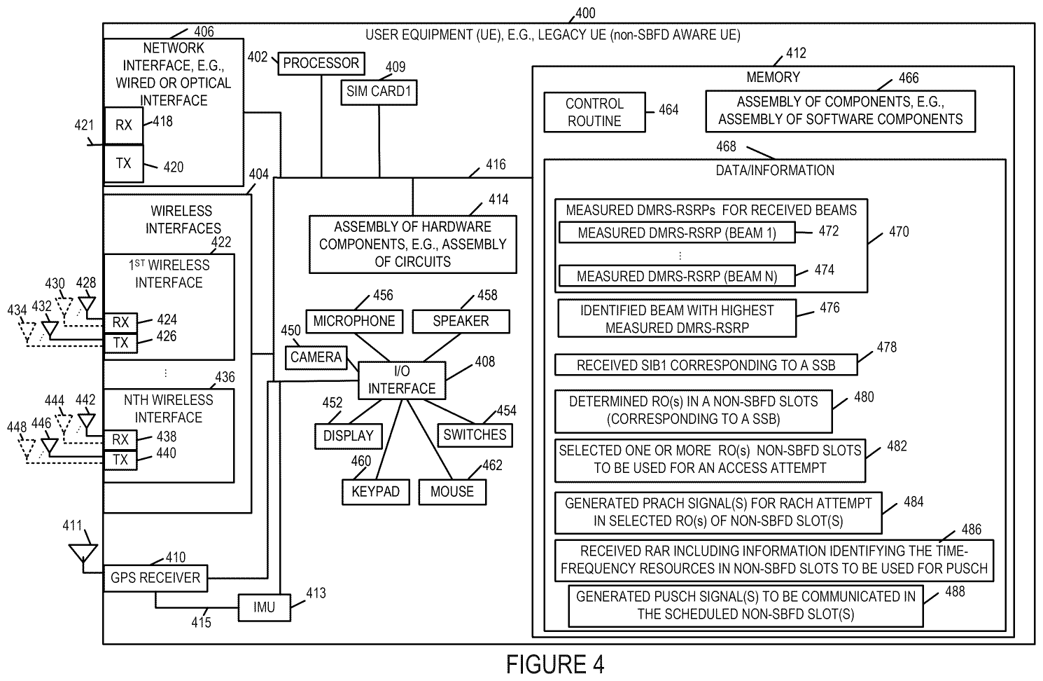

FIG. 4 is a drawing of an exemplary user equipment (UE) 400, e.g., a legacy UE, in accordance with an exemplary embodiment. A legacy UE is sometimes referred to as a non-SBFD aware UE, a non-SBFD capable UE or a non-SBFD enabled UE. Exemplary UE 400 of FIG. 4 is, e.g., any of UEs (110, 112, 118, 120) of system 100 of FIG. 1.

Exemplary UE 400 includes a processor 402, e.g., a CPU, wireless interfaces 404, a network interface 406, e.g., a wired or optical interface, I/O interface 408, GPS receiver 410, inertial measurement unit (IMU) 413, and assembly of hardware components 414, e.g., an assembly of circuits, coupled together via bus 416 over which the various elements may interchange data and information. In various embodiments, UE 400 further includes SIM card 1 409 coupled to bus 416.

Wireless interfaces 404 includes a plurality of wireless interfaces (1st wireless interface 422, . . . , Nth wireless interface 436). 1st wireless interface 422 includes wireless receiver 424 and wireless transmitter 426. Wireless receiver 424 is coupled to one or more receiver antennas (428, . . . , 430) via which the UE 400 receives wireless downlink signals from base stations. Wireless transmitter 426 is coupled to one or more transmit antennas (432, . . . , 434) via which the UE 400 transmits wireless uplink signals to base stations. In some embodiments one or more antennas are used by both the receiver 424 and transmitter 426. Nth wireless interface 436 includes wireless receiver 438 and wireless transmitter 440. Wireless receiver 438 is coupled to one or more receive antennas (442, . . . , 444) via which the UE 400 receives wireless downlink signals from base stations. Wireless transmitter 440 is coupled to one or more transmit antennas (446, . . . , 448) via which the UE 400 transmits wireless uplink signals to base stations. In some embodiments one or more antennas are used by both the receiver 438 and transmitter 440. In some embodiments different wireless interfaces correspond to different communications bands, different spectrum, and/or different communications protocols.

Network interface 406, e.g., a wired or optical interface, includes receiver 418, transmitter 420 and connector 421. Network interface 406 may, and sometimes does, couple UE 400 to base stations, network nodes and/or the Internet, e.g., when the UE 400 is stationary and located at a site with a wireline and/or optical connection.

GPS receiver 410 is coupled to GPS antenna 411. GPS receiver 410 is further coupled to IMU 413, e.g., an IMU on a chip including gyroscopes and accelerometers. GPS signals, received via GPS receive antenna 411, are processed by the GPS receiver 410 to determine time, position, e.g. latitude, longitude and altitude, and velocity information of UE 400. In some embodiments, information from IMU 413, e.g., accelerometer and/or gyroscopes measurements over time, are used, in conjunction with or in place of GPS measurements to determine position, e.g. latitude, longitude and altitude, and velocity information of UE 400. SIM card 1 409 includes information corresponding to a first communications network operator to which the owner of UE 400 is a subscriber.

UE 400 further includes a plurality of I/O devices (camera 450, display 452, e.g., a touch screen display, switches 454, microphone 456, speaker 458, keypad 460 and mouse 462) coupled to I/O interface 408, which couples the various I/O devices to other elements of the UE 400 via bus 416.

Memory 412 includes a control routine 464, an assembly of components 466, e.g., an assembly of software components, and data/information 468. Control routine 464 includes instructions which when executed by processor 402 control the UE 400 to implement basic operational functions, e.g., read memory, write to memory, control an interface, load a program, subroutine, or app, etc. Assembly of components 466, e.g., an assembly of software components, e.g., routines, subroutines, applications, etc., includes, e.g., code, e.g., machine executable instructions, which when executed by processor 402, controls the UE 400 to implement steps of a method in accordance with an exemplary embodiment of the present invention. Data/information 468 includes measured DMRS-RSRPs for received beams 470 (a measured DMRS-RSRP corresponding to beam 1 472, . . . , a measured DMRS-RSRP corresponding to beam N 474), and information 476, identifying the beam with the highest measured DMRS-RSRP. Data/information 468 further includes a received SIB1 corresponding to a SSB 478, determined ROs in non-SBFD slots 480, which may be used by UE 400, information 482 identifying a selected one or more ROs in non-SBFD slots to be used for an access attempt, and generated PRACH signals 474 for a RACH attempt in RACH occasion (RO) of a non-SBFD slot, a received RAR 486 including information identifying the time-frequency resources in non-SBFD slot(s) to be used by UE 400 for PUSCH transmission(s), and generated PUSCH signal(s) 488, e.g. conveying a RRC setup request message, to be communicated on the scheduled non-SBFD slot(s).

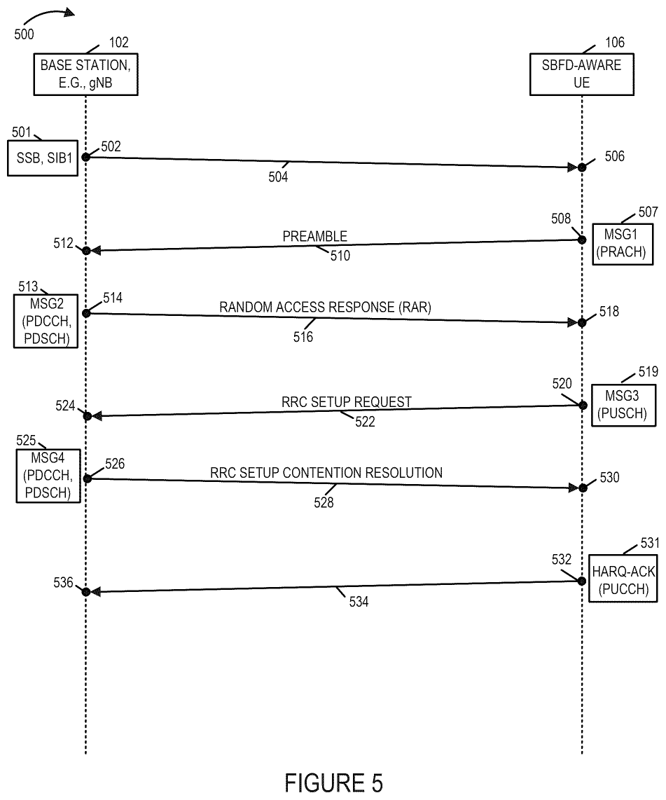

FIG. 5 is a signaling diagram 500 illustrating a 4-step RACH access method, being performed between exemplary base station 102, e.g., a gNB, and exemplary SBFD-aware UE 106, in accordance with an exemplary embodiment. Information box 501 indicates that that base station 102 will broadcast Synchronization Signaling Block (SSB) beams conveying System Information Block (SIB) information including System Information Block 1 (SIB1) information. The SIB1 information includes information identifying the timing-frequency structure being implemented by the base station 102, said timing-frequency structure including SBFD slots and non-SBFD slots. In step 502 base station 102 generates and transmits, e.g., broadcasts, SSB beam(s) 504 conveying System Information Block Information including SIB1 information. In step 506, UE 106 detects and receives one or more SSB beams, measures a received signal power, e.g. a DMRS-RSRP corresponding to each of the received SSB beams, identifies a strongest received SSB beam based on RSRP, and recovers the SIB1 information corresponding to the strongest detected SSB.

Information box 507 indicates that UE 106 will send a message 1 (msg1) using PRACH resources, as part of the 4-step access method. In step 508 UE 106 generates and sends a msg1 signal 510 which includes a preamble on RACH Occasion (RO) time-frequency resources of the PRACH, which UE 106 is allowed to use, to base station 102, which receives the PRACH signal 510 successfully in step 512 and recovers the communicated information.

Information box 513 indicates that the base station 102 will send a msg2 using PDCCH and PDSCH resources, as part of the 4-step access method. In step 514, in response to the successfully received PRACH signal from UE 106, base station 102 generates and sends a msg2 signal 516, which includes a random access response (RAR) message, to UE 106, which receives the RAR message in step 518 and recovers the communicated information, e.g., information indicating: PUSCH channel resources, e.g., one or more PUSCH occasions (POs), which have been assigned (scheduled) to be used by the UE 106, a PUSCH signal transmission power level, a frequency hopping flag, and a number of repetitions.

Information box 519 indicates that UE 106 will send a msg3 522 using PUSCH resources, as part of the 4-step access method. In step 520 UE 106 generates and sends a msg3 PUSCH signal transmission, which is a RRC setup request message 522, to base station 102 in accordance with the information in the received RAR 516, e.g., the UE 106 uses the indicated scheduled time-frequency PUSCH resources to send msg3, transmits msg3 at the indicated transmission power level and sends the indicated number of PUSCH signal repetitions. In step 524, base station 102 receives the RRC setup request message 522 and recovers the communicated information.

Information box 525 indicates that base station 102 will send a msg4 using PDCCH and PDSCH resources, as part of the 4-step access method. In step 526 base station 102 generates and sends msg4, which is a RRC setup contention resolution message 528, to UE 106, which receives the message 528 in step 530 and recovers the communicated information.

Information box 531 indicates that UE 106 will send a HARQ-ACK to base station 102 using PUCCH resources, as part of the 4-step access method. In step 532 UE 106 generates and sends the HARQ-ACK 534 to base station 102, which receives the HARQ-ACK 524 in step 536.

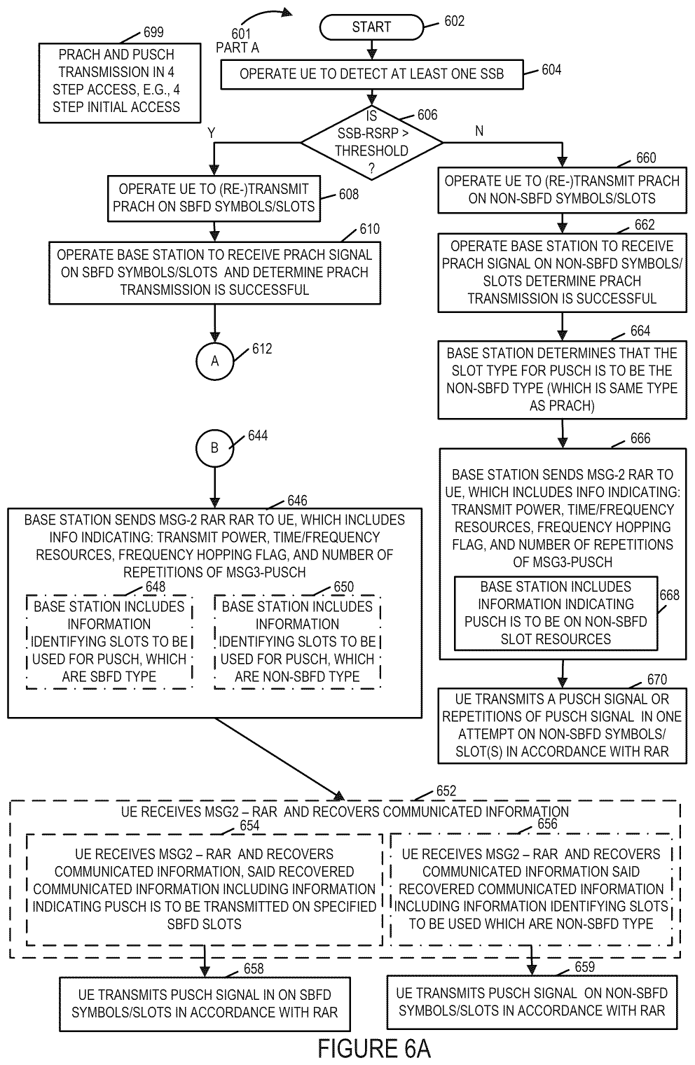

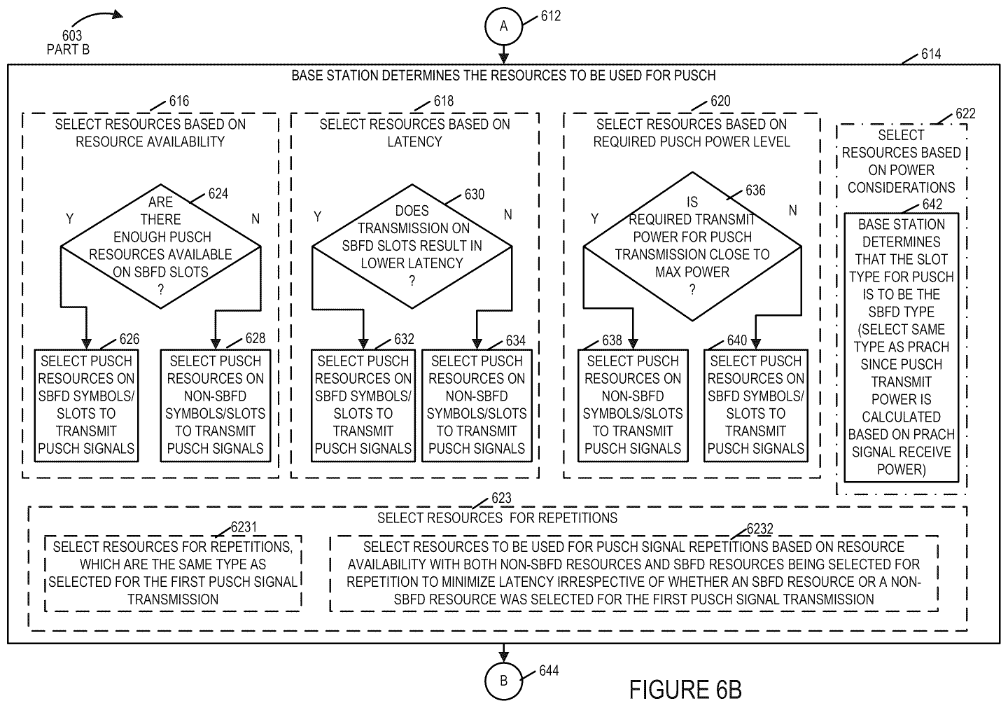

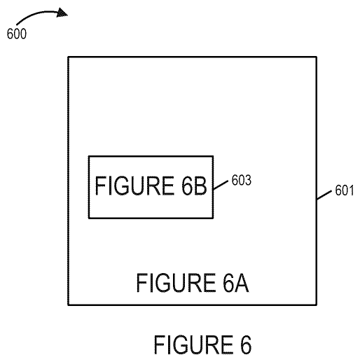

FIG. 6, which comprises the combination of Part A 601 of FIG. 6A and Part B 603 of FIG. 6B, is a flowchart 600 of an exemplary communications method including PRACH and PUSCH transmission in a 4 step access, e.g., a 4-step initial access, in accordance with an exemplary embodiment, as indicated by title box 699. The exemplary method of flowchart 600 is, e.g., performed by a base station, e.g., a gNB, and a SBFD-aware UE. The exemplary base station is, e.g., one of base station 1 102 or base station M 104 of system 100 of FIG. 1 and one of the SBFD-aware UE (UE1A 106, UENA 108, UE1C 114, UENC 116) of system 100 of FIG. 1. Operation of the exemplary method starts in step 602, in which the base station, e.g., BS 1 102, and the SFBFD-aware UE, e.g. UE 1A 106, are powered on and initialized. The base station starts transmitting one or more SSB beams. Operation proceeds from start step 602 to step 604.

In step 604 the UE detects at least one Synchronization Signal Block (SSB) beam, measures the received strength of each detected beam, e.g. measures a SSB-RSRP, for each detected beam, identifies a strongest beam, and recovers information corresponding to the strongest detected SSB beam, said recovered information including System Information Block 1 (SIB1) information. Operation proceeds from step 604 to step 606.

In step 606 the UE compares the SSB-RSRP of the strongest detected SSB beam, to a threshold. If the SSB-RSRP is determined to be greater than the threshold, then operation proceeds from step 606 to step 608. However, the SSB-RSRP is not determined to be greater than the threshold, then operation proceeds from step 606 to step 660. In step 660, the UE is operated to transmit (e.g., for an initial access attempt) or re-transmit (for an additional access attempt following failure of the initial access attempt) PRACH signal including a preamble on non-SBFD symbols/slots. Operation proceeds from step 660 to step 662. In step 662, the base station receives the PRACH signal on non-SBFD symbols/slots and determines that the PRACH transmission was successful. Operation proceeds from step 662 to step 664. In step 664 the base station determines that the slot type for PUSCH is to be the non-SBFD type, which is the same slot type used for the successful PRACH transmission. In various embodiments, when the base station receives a PRACH on a non-SBFD symbol/slot, the base station does not know whether or not the UE, which transmitted the received PRACH was a SBFD-aware UE, and thus the base station schedules the PUSCH on non-SBFD symbols/slots, e.g., in case the UE was a non-SBFD aware UE (legacy UE). This approach allows legacy UE operations to continue normally. Operation proceeds from step 664 to step 666.

In step 666 the base station generates and sends msg-2 random access response (RAR) to the UE, said RAR includes information corresponding to the PUSCH. The information included in RAR includes information indicating: transmit power, time/frequency resources, frequency hopping flag setting, and a number of repetitions of the msg3-PUSCH. Step 666 includes step 668 in which the base station includes information indicating PUSCH transmission is to be on non-SBFD slot resources, e.g., the selected set of resources for the PUSCH transmission corresponding to non-SBFD symbols/slots. Operation proceeds from step 666 to step 670, in which the UE transmits a PUSCH signal or PUSCH repetitions in one attempt on non-SBFD symbols/slot(s) in accordance with the received RAR.

Returning to step 608, in step 608, the UE is operated to transmit (e.g., for an initial access attempt) or re-transmit (for an additional access attempt following failure of the initial access attempt) PRACH signal including a preamble on SBFD symbols/slots. Operation proceeds from step 608 to step 610. In step 610, the base station receives the PRACH signal on SBFD symbols/slots and determines that the PRACH transmission was successful. Operation proceeds from step 610, via connecting node A 612 to step 614 of FIG. 6B.

In step 614 the base station determines the resources to be used for the PUSCH signal transmission. Depending upon the particular implemented embodiment, the base station performs one of alternative steps 616, 618, 610 or 610.

In some embodiments, the base station performs step 616, in which the base station selects resources to be used for the PUSCH transmission based on resource availability. Step 616 includes steps 624, 626 and 628. In step 624, the base station determines if there are enough PUSCH resources available, to be allocated to the UE, on SBFD slots to perform the PUSCH transmission. If the determination of step 624 is that there are enough PUSCH resources available on SBFD slots to transmit PUSCH signals, then operation proceeds from step 624 to step 626, in which the base station selects PUSCH resources on SBFD symbols/slots to transmit PUSCH signals. However, if the determination of step 624 is that there are not enough PUSCH resources available on SBFD slots to transmit PUSCH signals, then operation proceeds from step 624 to step 628, in which the base station selects PUSCH resources on non-SBFD symbols/slots to transmit PUSCH signals.

In some embodiments, the base station performs step 618, in which the base station selects resources to be used for PUSCH transmission based on latency considerations. Step 618 includes steps 630, 632 and 634. In step 630 the base station determines if transmission on SFBD slots results in lower latency. If the determination of step 630 is that transmission on SBFD slots results in lower latency, then operation proceeds from step 630 to step 632, in which the base station selects PUSCH resources on SBFD symbols/slots to transmit PUSCH signals. However, if the determination of step 630 is that transmission on SBFD slots does not result in lower latency, then operation proceeds from step 630 to step 634, in which the base station selects PUSCH resources on non-SBFD symbols/slots to transmit PUSCH signals.

In some embodiments, the base station performs step 620, in which the base station selects resources to be used for PUSCH transmission based on required PUSCH power level. Step 620 includes steps 636, 638 and 640. In step 636 the base station determines if the required transmit power for PUSCH is close to a maximum power. If the required transmit power for PUSCH is close to the maximum power, that may be indicative of poor channel quality, e.g., a high level of transmit power is required to overcome a high level of interference on a channel using SBFD symbols/slots, and in such a situation it might be better to try a different channel, e.g., a channel using non-SBFD symbols/slots. If the determination of step 620 is that the required transmit power for the PUSCH signal is close to the maximum power, then operation proceeds from step 636 to step 638, in which the base station selects PUSCH resources on non-SBFD symbols/slots to transmit PUSCH signals. However, if the determination of step 620 is that transmission on SBFD slots is not close to maximum power, then operation proceeds from step 636 to step 640, in which the base station selects PUSCH resources on SBFD symbols/slots to transmit PUSCH signals.

In some embodiments, the base station performs step 622, in which the base station selects resources to be used for PUSCH transmission based on power considerations, e.g., in step 622 the UE selects resources to be used for PUSCH signaling based on the resource type of a received signal whose power is used to control the transmit power level to be used for UE PUSCH transmission by the UE. Step 632 includes step 642, in which the base station determines that the slot type for PUSCH transmission is to be the SBFD slot type. The base station selects the same type of slot type for PUSCH transmission, as the slot type used for the previously transmitted successfully received PRACH signal, since the PUSCH transmit power is typically calculated based on PRACH signal receive power.

In some embodiments, step 614 includes step 623, in which the base station selects resources for PUSCH repetitions. Step 623 includes optional steps 6231 and 6232. In step 6231 the base station selects resources for repetitions, which are the same type as selected for the first PUSCH signal repetition. In step 6232 the base station selects resources to be used for PUSCH signal repetitions based on resource availability with both non-SBFD resources and SFBD resources being selected for repetition to minimize latency irrespective of whether an SBFD resource or a non-SBFD resource was selected for the first PUSCH signal transmission.

Operation proceeds from step 614, via connecting node B 644, to step 646 of FIG. 6A. In step 646 the base station generates and sends a msg-2 RAR to the UE. The msg-2 RAR includes information, corresponding to the PUSCH, indicating: transmit power, time/frequency resources, frequency hopping flag, and number of repetitions of msg3-PUSCH signal. Step 646 includes one of alternative steps 648 and 650, based on the determination of step 614. In step 646, the base station includes information identifying slots to be used by the UE for PUSCH transmission, said slots being SBFD type slots, e.g., the RAR allocates resources to the UE to be used for PUSCH which are in SBFD type slots. In step 650, the base station includes information identifying slots to be used by the UE for PUSCH transmission, said slots being non-SBFD type slots, e.g., the RAR allocates resources to the UE to be used for PUSCH which are in non-SBFD type slots.

Operation proceeds from step 646 to step 652, in which the UE receives the msg2-RAR and recovers the communicated information. Step 652 includes one of alternative step 654 and step 656. In step 654, the base station receives msg2-RAR and recovers communicated information, said recovered communicated information including information indication PUSCH signal is to be transmitted on specified allocated resources of SBFD slots. In step 656, the base station receives msg2-RAR and recovers communicated information, said recovered communicated information including information indication PUSCH signal is to be transmitted on specified allocated resources of non-SBFD slots.

Operation proceeds from step 654 to step 658, in which the UE transmits PUSCH signal in SBFD symbols/slots in accordance with the received RAR. Alternatively, operation proceeds from step 656 to step 660, in which the UE transmits PUSCH signal on non-SBFD symbols/slots in accordance with the received RAR.

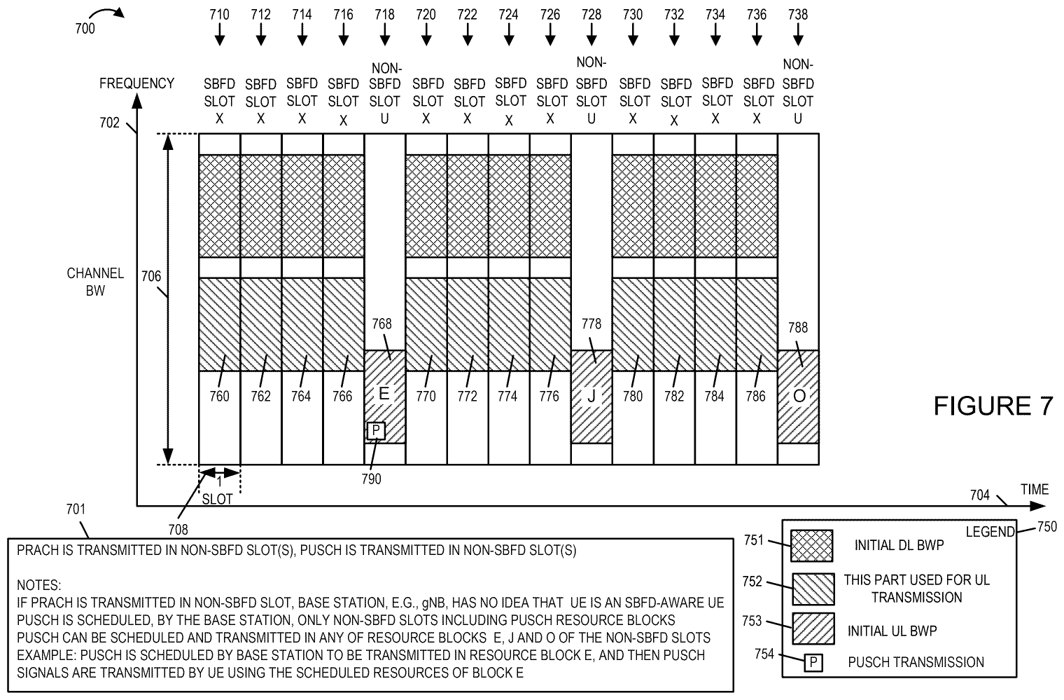

FIG. 7 is a drawing 700 illustrating an example, in which a PUSCH transmission for a SBFD-aware UE is scheduled, by a base station, to be in non-SBFD slot(s) of a timing-frequency structure including SBFD slots and non-SBFD slots, following transmission of PRACH signal by the UE in a non-SBFD slot, in accordance with an exemplary embodiment. Drawing 700 illustrates an exemplary timing-frequency structure including SBFD slots and non-SBFD slots. Vertical axis 702 represents frequency, while horizontal axis 704 represents time. Frequency range 706 corresponds to an exemplary channel bandwidth (BW) being used by the base station. An exemplary timing slot interval 708 is shown for a first slot, which is slot 710.

FIG. 7 further includes legend 750, which indicates: i) crosshatch shading, as shown in sample block 751, is used to identify an initial downlink (DL) bandwidth part (BWP), ii) left to right descending line shading, as shown in sample block 752, is used to identify parts of the SBFD slots which are to be used for uplink (UL) transmission, iii) left to right ascending line shading, as shown in sample block shading 753, is used to identify an initial UL BWP, and iv) a small block including “P”, as shown in sample 754, is used to identify a PUSCH transmission.

The exemplary timing-frequency structure of drawing 700 includes: slot 710, which is a SBFD type slot, indicated by designation “X”; slot 712, which is a SBFD type slot, indicated by designation “X”; slot 714, which is a SBFD type slot, indicated by designation “X”; slot 716, which is a SBFD type slot, indicated by designation “X”; slot 718, which a non-SBFD uplink type slot, indicated by designation “U”; slot 720, which is a SBFD type slot, indicated by designation “X”; slot 722, which is a SBFD type slot, indicated by designation “X”; slot 724, which is a SBFD type slot, indicated by designation “X”; slot 726, which is a SBFD type slot, indicated by designation “X”; slot 728, which a non-SBFD uplink type slot, indicated by designation “U”; slot 730, which is a SBFD type slot, indicated by designation “X”; slot 732, which is a SBFD type slot, indicated by designation “X”; slot 734, which is a SBFD type slot, indicated by designation “X”; slot 736, which is a SBFD type slot, indicated by designation “X”; and slot 738, which a non-SBFD uplink type slot, indicated by designation “U”. It may be observed that each of SBFD slots includes a portion which may be used for DL and a portion which may be used for UL.

Information block 701 indicates that if PRACH signal is transmitted in non-SBFD slot(s), PUSCH signal (corresponding to the PRACH) is transmitted in non-SBFD slots. If a PRACH signal including a Preamble is transmitted, by a UE, in a non-SBFD slot, the base station, e.g. gNB, which receives the PRACH signal, has no idea that the UE, which transmitted the PRACH signal, is an SBFD-aware UE. Note that the base station can receive PRACH signals from both SBFD aware UEs and non-SBFD aware UEs (legacy UEs) on non-SBFD slot resources. PUSCH transmission (for the UE) is scheduled, by the base station, only on non-SBFD slots including PUSCH resource blocks. In this example, the PUSCH can be scheduled and transmitted in any of: resource block E 768 of non-SBFD slot 718, resource block J 778 of non-SBFD slot 728 or resource block O 788 of non-SBFD slot 738. In this example, the PUSCH transmission is scheduled, by the base station, to be in resource block E 768, using the resources 790, e.g. a PUSCH occasion (PO) time-frequency block. The UE, which receives, e.g. in a RAR message, PUSCH scheduling information, subsequently transmits the PUSCH signals, e.g., communicating an RRC setup request, on resources 790 of the UL BWP 768 of the non-SBFD slot 718.

In this example, the PUSCH transmission, which corresponds to a successfully received PRACH signal on a non-SBFD RACH Occasion (RO) of a non-SBFD slot, is not allowed to be scheduled in UL resources (760, 762, 764, 766, 770, 772, 774, 776, 780, 782, 784, 786) of SBFD slots (710, 712, 714, 716, 720, 722, 724, 726, 730, 732, 734, 736), respectively.

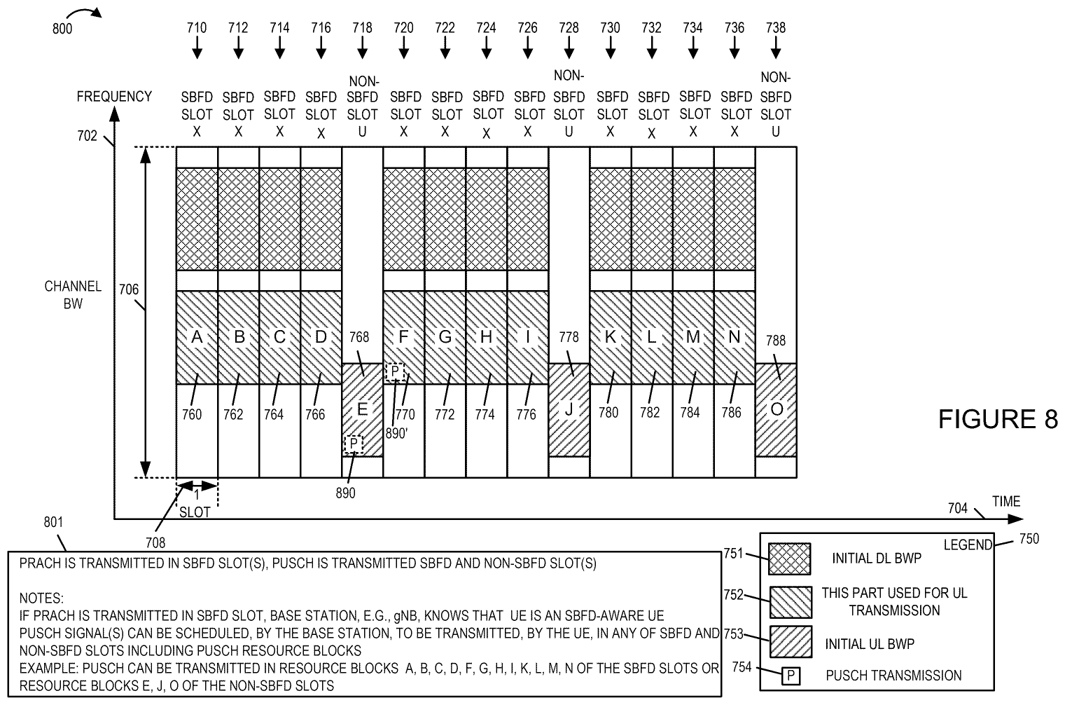

FIG. 8 is a drawing 800 illustrating an example, in which PUSCH transmission(s) for a SBFD-aware UE is scheduled, by a base station, to be in SBFD and non-SBFD slot(s) of a timing-frequency structure including SBFD slots and non-SBFD slots, following transmission PRACH signal(s) by the UE in a SBFD slot(s), in accordance with an exemplary embodiment. Drawing 800 illustrates an exemplary timing-frequency structure including SBFD slots and non-SBFD slots. Vertical axis 702 represents frequency, while horizontal axis 704 represents time. Frequency range 706 corresponds to an exemplary channel bandwidth (BW) being used by the base station. An exemplary timing slot interval 708 is shown for a first slot, which is slot 710.

FIG. 8 further includes legend 750, which indicates: i) crosshatch shading, as shown in sample block 751, is used to identify an initial downlink (DL) bandwidth part (BWP), ii) left to right descending line shading, as shown in sample block 752, is used to identify parts of the SBFD slots which are to be used for uplink (UL) transmission, iii) left to right ascending line shading, as shown in sample block shading 753, is used to identify an initial UL BWP, and iv) a small block including “P”, as shown in sample 754, is used to identify a PUSCH transmission.

The exemplary timing-frequency structure of drawing 800 includes: slot 710, which is a SBFD type slot, indicated by designation “X”; slot 712, which is a SBFD type slot, indicated by designation “X”; slot 714, which is a SBFD type slot, indicated by designation “X”; slot 716, which is a SBFD type slot, indicated by designation “X”; slot 718, which a non-SBFD uplink type slot, indicated by designation “U”; slot 720, which is a SBFD type slot, indicated by designation “X”; slot 722, which is a SBFD type slot, indicated by designation “X”; slot 724, which is a SBFD type slot, indicated by designation “X”; slot 726, which is a SBFD type slot, indicated by designation “X”; slot 728, which a non-SBFD uplink type slot, indicated by designation “U”; slot 730, which is a SBFD type slot, indicated by designation “X”; slot 732, which is a SBFD type slot, indicated by designation “X”; slot 734, which is a SBFD type slot, indicated by designation “X”; slot 736, which is a SBFD type slot, indicated by designation “X”; and slot 738, which a non-SBFD uplink type slot, indicated by designation “U”. It may be observed that each of SBFD slots includes a portion which may be used for DL and a portion which may be used for UL.

Information block 801 indicates that if PRACH signal is transmitted in SBFD slot(s), PUSCH signal (corresponding to the PRACH) can be transmitted in SBFD and/or non-SBFD slots. If a PRACH signal including a Preamble is transmitted, by a UE, in a SBFD slot, the base station, e.g. gNB, which receives the PRACH signal, knows that the UE, which transmitted the PRACH signal, is an SBFD-aware UE, since non-SBFD aware UEs (legacy UEs) do not transmit PRACH signals in SBFD slots. Note that the base station only receives PRACH signals on SBFD slot resources from SBFD aware UEs. PUSCH transmission (for the UE) can be scheduled, by the base station, on any of the SBFD or non-SBFD slots including PUSCH resource blocks. In this example, the PUSCH can be scheduled, by the base station, and transmitted, by the UE, on any of: resource blocks (resource block A 760, resource block B 762, resource block C 764, resource block D 766, resource block F 770, resource block G 772, resource block H 774, resource block I 776, resource block J 778, resource block K 780, resource block L 782, resource block M 784, resource block N 786) of SBFD slots (710, 712, 714, 716, 720, 722, 724, 726, 730, 732, 734, 736), respectively, and resource block (resource block E 768, resource block J 778, resource block O 788) of non-SBFD slots (718, 728, 738), respectively.

In this example, the PUSCH transmission is scheduled, by the base station, to be in resource block E 768, using the resources 890, e.g. a PUSCH occasion (PO) time-frequency block or alternatively the PUSCH transmission is scheduled, by the base station, to be in resource block F 770, using the resources 890′, e.g. another PUSCH occasion (PO) time-frequency block. The UE, which receives, e.g., in a RAR message, PUSCH scheduling information indicating PO 890 or PO 890′, subsequently transmits the PUSCH signal, e.g., communicating an RRC setup request, on the indicated resources.

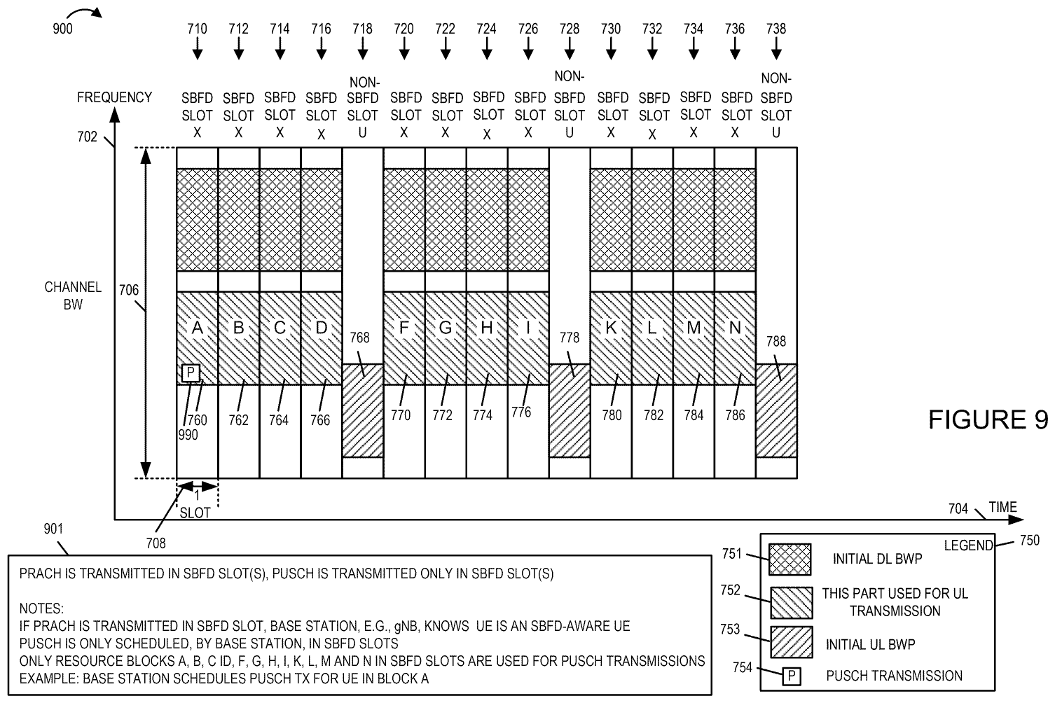

FIG. 9 is a drawing 900 illustrating an example, in which PUSCH transmission(s) for a SBFD-aware UE is scheduled, by a base station, to be in only SBFD slot(s) of a timing-frequency structure including SBFD slots and non-SBFD slots, following transmission of PRACH signal(s) by the UE in a SBFD slot(s), in accordance with an exemplary embodiment. Drawing 900 illustrates an exemplary timing-frequency structure including SBFD slots and non-SBFD slots. Vertical axis 702 represents frequency, while horizontal axis 704 represents time. Frequency range 706 corresponds to an exemplary channel bandwidth (BW) being used by the base station. An exemplary timing slot interval 708 is shown for a first slot, which is slot 710.

FIG. 9 further includes legend 750, which indicates: i) crosshatch shading, as shown in sample block 751, is used to identify an initial downlink (DL) bandwidth part (BWP), ii) left to right descending line shading, as shown in sample block 752, is used to identify parts of the SBFD slots which are to be used for uplink (UL) transmission, iii) left to right ascending line shading, as shown in sample block shading 753, is used to identify an initial UL BWP, and iv) a small block including “P”, as shown in sample 754, is used to identify a PUSCH transmission.

The exemplary timing-frequency structure of drawing 900 includes: slot 710, which is a SBFD type slot, indicated by designation “X”; slot 712, which is a SBFD type slot, indicated by designation “X”; slot 714, which is a SBFD type slot, indicated by designation “X”; slot 716, which is a SBFD type slot, indicated by designation “X”; slot 718, which a non-SBFD uplink type slot, indicated by designation “U”; slot 720, which is a SBFD type slot, indicated by designation “X”; slot 722, which is a SBFD type slot, indicated by designation “X”; slot 724, which is a SBFD type slot, indicated by designation “X”; slot 726, which is a SBFD type slot, indicated by designation “X”; slot 728, which a non-SBFD uplink type slot, indicated by designation “U”; slot 730, which is a SBFD type slot, indicated by designation “X”; slot 732, which is a SBFD type slot, indicated by designation “X”; slot 734, which is a SBFD type slot, indicated by designation “X”; slot 736, which is a SBFD type slot, indicated by designation “X”; and slot 738, which a non-SBFD uplink type slot, indicated by designation “U”. It may be observed that each of SBFD slots includes a portion which may be used for DL and a portion which may be used for UL.

Information block 901 indicates that if PRACH signal is transmitted in SBFD slot(s), PUSCH signal (corresponding to the PRACH) can be transmitted only in SBFD slots, in accordance with the exemplary embodiment. If a PRACH signal including a Preamble is transmitted, by a UE, in a SBFD slot, the base station, e.g. gNB, which receives the PRACH signal, knows that the UE, which transmitted the PRACH signal, is an SBFD-aware UE, since non-SBFD aware UEs (legacy UEs) do not transmit PRACH signals in SBFD slots. Note that the base station only receives PRACH signals on SBFD slot resources from SBFD aware UEs. In accordance with the exemplary embodiment of FIG. 9, PUSCH transmission (for the UE) is scheduled, by the base station, in SBFD slot(s) including PUSCH resource blocks. In this example, the PUSCH can be scheduled, by the base station, and transmitted, by the UE, on any of: resource blocks (resource block A 760, resource block B 762, resource block C 764, resource block D 766, resource block F 770, resource block G 772, resource block H 774, resource block I 776, resource block J 778, resource block K 780, resource block L 782, resource block M 784, resource block N 786) of SBFD slots (710, 712, 714, 716, 720, 722, 724, 726, 730, 732, 734, 736), respectively. The PUSCH transmission cannot be scheduled on resource block (resource block 768, resource block 778, resource block 788) of non-SBFD slots (718, 728, 738), respectively.

In this example, the PUSCH transmission is scheduled, by the base station, to be in resource block A 760, using the resources 990, e.g. a PUSCH occasion (PO) time-frequency block. The UE, which receives, e.g., in a RAR message, the PUSCH scheduling information indicating PO 990, subsequently transmits the PUSCH signal, e.g., communicating an RRC setup request, on the indicated resources.

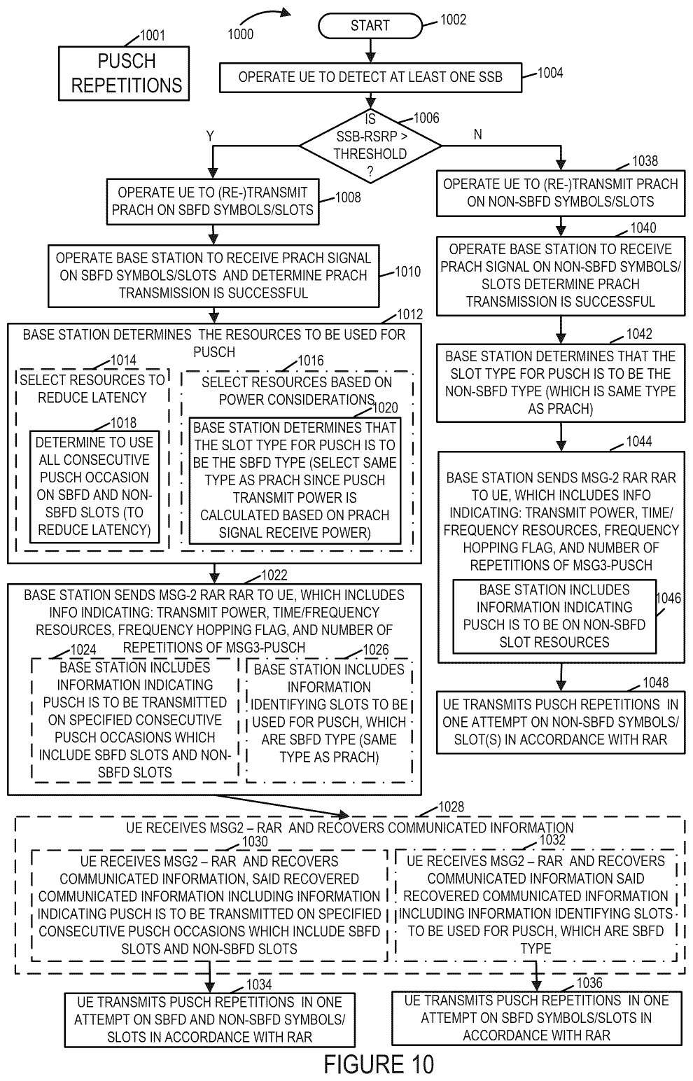

FIG. 10 is a flowchart 1000 of an exemplary communications method including PUSCH transmission repetitions, in accordance with an exemplary embodiment, as indicated by title box 1001. The exemplary method of flowchart 1000 is, e.g., performed by a base station, e.g., a gNB, and a SBFD-aware UE. The exemplary base station is, e.g., one of base station 1 102 or base station M 104 of system 100 of FIG. 1 and one of the SBFD-aware UE (UE1A 106, UENA 108, UE1C 114, UENC 116) of system 100 of FIG. 1. Operation of the exemplary method starts in step 1002, in which the base station, e.g., BS 1 102, and the SBFD-aware UE, e.g. UE 1A 106, are powered on and initialized. The base station starts transmitting one or more SSB beams. Operation proceeds from start step 1002 to step 1004.

In step 1004 the UE detects at least one Synchronization Signal Block (SSB) beam, measures the received strength of each detected beam, e.g. measures a SSB-RSRP, for each detected beam, identifies a strongest beam, and recovers information corresponding to the strongest detected SSB beam, said recovered information including System Information Block 1 (SIB1) information. Operation proceeds from step 1004 to step 1006.

In step 1006 the UE compares the SSB-RSRP of the strongest detected SSB beam, to a threshold. If the SSB-RSRP is determined to be greater than the threshold, then operation proceeds from step 1006 to step 1008. However, the SSB-RSRP is not determined to be greater than the threshold, then operation proceeds from step 1006 to step 1038. In step 1038, the UE is operated to transmit (e.g., for an initial access attempt) or re-transmit (for an additional access attempt following failure of the initial access attempt) PRACH signal including a preamble on non-SBFD symbols/slots. Operation proceeds from step 1038 to step 1040. In step 1040, the base station receives the PRACH signal on non-SBFD symbols/slots and determines that the PRACH transmission was successful. Operation proceeds from step 1040 to step 1042. In step 1042 the base station determines that the slot type for PUSCH is to be the non-SBFD type, which is the same slot type used for the successful PRACH transmission. In various embodiments, when the base station receives a PRACH on a non-SBFD symbol/slot, the base station does not know whether or not the UE, which transmitted the received PRACH was a SBFD-aware UE, and thus the base station schedules the PUSCH on non-SBFD symbols/slots, e.g., in case the UE was a non-SBFD aware UE (legacy UE). This approach allows legacy UE operations to continue normally. Operation proceeds from step 1042 to step 1044.

In step 1044 the base station generates and sends msg-2 random access response (RAR) to the UE, said RAR includes information corresponding to the PUSCH. The information included in RAR includes information indicating: transmit power, time/frequency resources, frequency hopping flag setting, and a number of repetitions of the msg3-PUSCH. Step 1044 includes step 1046, in which the base station includes information indicating PUSCH transmission is to be on non-SBFD slot resources, e.g., the selected set of resources for the PUSCH transmission corresponding to non-SBFD symbols/slots. Operation proceeds from step 1044 to step 1048, in which the UE transmits PUSCH repetitions in one attempt on non-SBFD symbols/slot(s) in accordance with the received RAR.

Returning to step 1008, in step 1008, the UE is operated to transmit (e.g., for an initial access attempt) or re-transmit (for an additional access attempt following failure of the initial access attempt) PRACH signal including a preamble on SBFD symbols/slots. Operation proceeds from step 1008 to step 1010. In step 1010, the base station receives the PRACH signal on SBFD symbols/slots and determines that the PRACH transmission was successful. Operation proceeds from step 1010 to step 1012.

In step 1012 the base station determines the resources to be used for the PUSCH signal transmission. Depending upon the particular implemented embodiment, the base station performs one of alternative steps 1014 and 1016.

In step 1014 the base station selects resources to be used for PUSCH transmission to reduce latency. Step 1014 includes step 1018 in which base station determines to uses all consecutive PUSCH Occasion on SBFD and non-SBFD slots (to reduce latency).

In step 1016 the base station selects the resources to be used for PUSCH transmission based on power considerations. Step 1016 includes step 1020, in which the base station determines that the slot type to be used for PUSCH transmission is to be the SBFD slot type. The base station determines to use the same type of slot (SBFD type slot) for PUSCH transmission as was used for the PRACH transmission since PUSCH transmit power is typically calculated, by the base station, based on PRACH signal receive power, measured by the base station. Thus in step 1016 the base station selects PUSCH Occasions which corresponding to only SBFD slots. Operation proceeds from step 1012 to step 1020.

In step 1022 the base station generates and sends a msg-2 RAR to the UE. The msg-2 RAR includes information, corresponding to the PUSCH, indicating: transmit power, time/frequency resources, frequency hopping flag, and number of repetitions of msg3-PUSCH signal. Step 1022 includes one of alternative steps 1024 and 1026. If the base station performed step 1014, then step 1026 is performed. However, if the base station performed step 1016, then step 1026 is performed.

In step 1024, the base station includes information indicating PUSCH signal is to be transmitted on specified consecutive PUSCH occasions (POs) which include SBFD and non-SBFD slots. In step 1026 the base station includes information identifying slots to be used for PUSCH, which are SBFD type slots, which is the same type of slot used for the successfully communicated PRACH signal, e.g., the base station communicates information identifying the POs assigned to the UE for PUSCH, which includes repetitions and the POs corresponding to SBFD slots.

Operation proceeds from step 1022 to step 1022, in which the UE receives the msg2-RAR and recovers the communicated information. Step 1022 includes one of alternative step 1030 and step 1032. In step 1030, the base station receives msg2-RAR and recovers communicated information, said recovered communicated information including information indicating PUSCH signal is to be transmitted on specified consecutive PUSCH occasions (POs) which correspond to SBFD slots and non-SBFD slots. In step 1032, the base station receives msg2-RAR and recovers communicated information, said recovered communicated information including information indication PUSCH signal is to be transmitted on specified allocated resources POs of SBFD slots.

Operation proceeds from step 1030 to step 1034, in which the UE transmits PUSCH signal repetitions on SBFD symbols/slots and non-SBFD symbols/slots in accordance with the received RAR. Alternatively, operation proceeds from step 1032 to step 1036, in which the UE transmits PUSCH signal repetitions on SBFD symbols/slots in accordance with the received RAR.

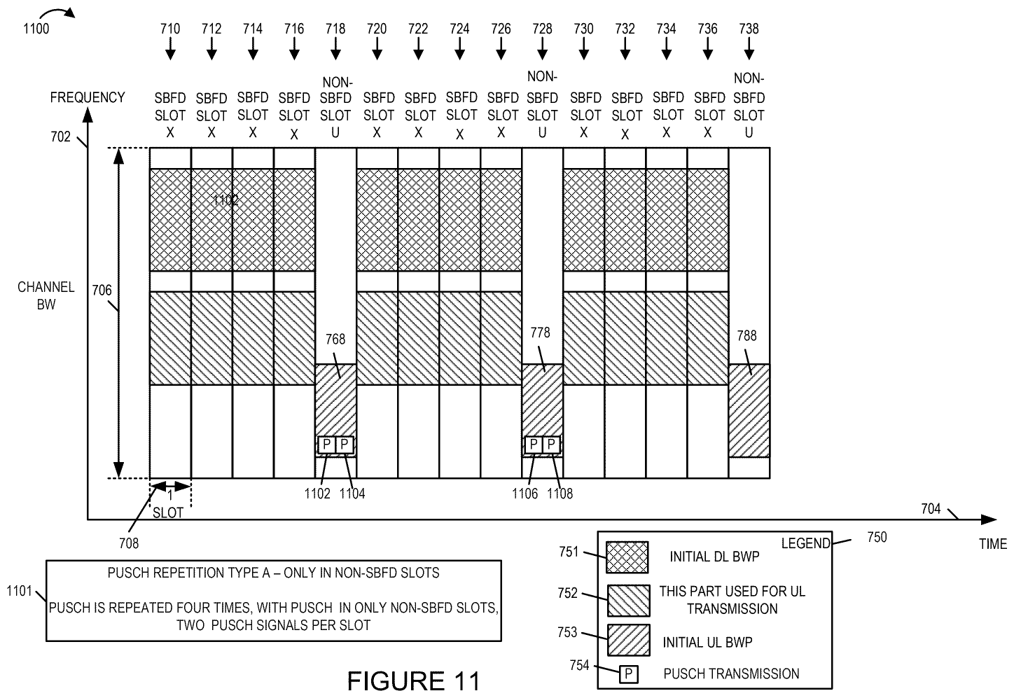

FIG. 11 is a drawing 1100 illustrating an example of a PUSCH repetition type A, in which PUSCH transmission is repeated in only non-SBFDs slots of a timing-frequency structure including SBFD slots and non-SBFD slots, as indicated in information block 1101. In the example of FIG. 11, PUSCH transmission is repeated four times, only in non-SBFD slots, with two PUSCH signals per slot. Drawing 1100 illustrates an exemplary timing-frequency structure including SBFD slots and non-SBFD slots. Vertical axis 702 represents frequency, while horizontal axis 704 represents time. Frequency range 706 corresponds to an exemplary channel bandwidth (BW) being used by the base station. An exemplary timing slot interval 708 is shown for a first slot, which is slot 710.

FIG. 11 further includes legend 750, which indicates: i) crosshatch shading, as shown in sample block 751, is used to identify an initial downlink (DL) bandwidth part (BWP), ii) left to right descending line shading, as shown in sample block 752, is used to identify parts of the SBFD slots which are to be used for uplink (UL) transmission, iii) left to right ascending line shading, as shown in sample block shading 753, is used to identify an initial UL BWP, and iv) a small block including “P”, as shown in sample 754, is used to identify a PUSCH transmission.

The exemplary timing-frequency structure of drawing 1100 includes: slot 710, which is a SBFD type slot, indicated by designation “X”; slot 712, which is a SBFD type slot, indicated by designation “X”; slot 714, which is a SBFD type slot, indicated by designation “X”; slot 716, which is a SBFD type slot, indicated by designation “X”; slot 718, which a non-SBFD uplink type slot, indicated by designation “U”; slot 720, which is a SBFD type slot, indicated by designation “X”; slot 722, which is a SBFD type slot, indicated by designation “X”; slot 724, which is a SBFD type slot, indicated by designation “X”; slot 726, which is a SBFD type slot, indicated by designation “X”; slot 728, which a non-SBFD uplink type slot, indicated by designation “U”; slot 730, which is a SBFD type slot, indicated by designation “X”; slot 732, which is a SBFD type slot, indicated by designation “X”; slot 734, which is a SBFD type slot, indicated by designation “X”; slot 736, which is a SBFD type slot, indicated by designation “X”; and slot 738, which a non-SBFD uplink type slot, indicated by designation “U”. It may be observed that each of SBFD slots includes a portion which may be used for DL and a portion which may be used for UL.

In this exemplary embodiment, the PUSCH signal repetition can be scheduled for transmission on any of: resource block 768 of non-SBFD slot 718, resource block 778 of non-SBFD slot 728, resource block 788 of non-SBFD slot 738. In this particular example, 2 PUSCH transmissions (as part a PUSCH repetition including 4 PUSCH transmissions) are scheduled, by the base station, to be in resource block 768, using time-frequency resources 1102, 1104, e.g. two consecutive PUSCH Occasions (POs), and 2 PUSCH transmissions (as part the PUSCH repetition including 4 PUSCH transmissions) are scheduled, by the base station, to be in resource block 778, using time-frequency resources 1106, 1108, e.g. two other consecutive PUSCH occasions (POs). The UE, which receives, e.g. in a RAR message, PUSCH scheduling information, which includes information identifying the four PUSCH Occasions (1102, 1104, 1106, 1108) subsequently transmits the PUSCH signals, e.g., communicating an RRC setup request, on resources 1102, 1104 of the UL BWP 768 of the non-SBFD slot 718 and on resources 1106, 1108 of the UL BWP 778 of the non-SBFD slot 728.

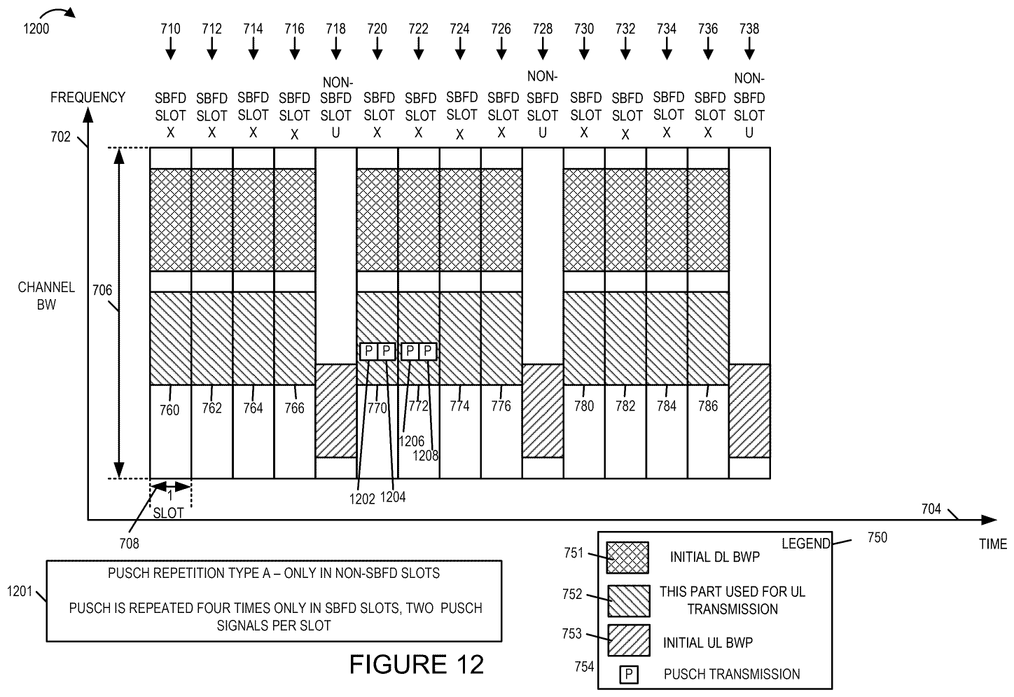

FIG. 12 is a drawing 1200 illustrating an example of a PUSCH repetition type A, in which PUSCH transmission is repeated in only SBFDs slots of a timing-frequency structure including SBFD slots and non-SBFD slots, as indicated in information block 1201. In the example of FIG. 12, PUSCH transmission is repeated four times, only in SBFD slots, with two PUSCH signals per slot. Drawing 1200 illustrates an exemplary timing-frequency structure including SBFD slots and non-SBFD slots. Vertical axis 702 represents frequency, while horizontal axis 704 represents time. Frequency range 706 corresponds to an exemplary channel bandwidth (BW) being used by the base station. An exemplary timing slot interval 708 is shown for a first slot, which is slot 710.

FIG. 12 further includes legend 750, which indicates: i) crosshatch shading, as shown in sample block 751, is used to identify an initial downlink (DL) bandwidth part (BWP), ii) left to right descending line shading, as shown in sample block 752, is used to identify parts of the SBFD slots which are to be used for uplink (UL) transmission, iii) left to right ascending line shading, as shown in sample block shading 753, is used to identify an initial UL BWP, and iv) a small block including “P”, as shown in sample 754, is used to identify a PUSCH transmission.

The exemplary timing-frequency structure of drawing 1200 includes: slot 710, which is a SBFD type slot, indicated by designation “X”; slot 712, which is a SBFD type slot, indicated by designation “X”; slot 714, which is a SBFD type slot, indicated by designation “X”; slot 716, which is a SBFD type slot, indicated by designation “X”; slot 718, which a non-SBFD uplink type slot, indicated by designation “U”; slot 720, which is a SBFD type slot, indicated by designation “X”; slot 722, which is a SBFD type slot, indicated by designation “X”; slot 724, which is a SBFD type slot, indicated by designation “X”; slot 726, which is a SBFD type slot, indicated by designation “X”; slot 728, which a non-SBFD uplink type slot, indicated by designation “U”; slot 730, which is a SBFD type slot, indicated by designation “X”; slot 732, which is a SBFD type slot, indicated by designation “X”; slot 734, which is a SBFD type slot, indicated by designation “X”; slot 736, which is a SBFD type slot, indicated by designation “X”; and slot 738, which a non-SBFD uplink type slot, indicated by designation “U”. It may be observed that each of SBFD slots includes a portion which may be used for DL and a portion which may be used for UL.

In this exemplary embodiment, the PUSCH signal repetition can be scheduled for transmission on any of: resource block 760 of SBFD slot 710, resource block 762 of SBFD slot 712, resource block 764 of SBFD slot 714, resource block 766 of SBFD slot 716, resource block 770 of SBFD slot 720, resource block 772 of SBFD slot 722, resource block 774 of SBFD slot 724, resource block 776 of SBFD slot 726, resource block 780 of SBFD slot 730, resource block 782 of SBFD slot 732, resource block 784 of SBFD slot 734, resource block 786 of SBFD slot 736. In this particular example, 2 PUSCH transmissions (as part a PUSCH repetition including 4 PUSCH transmissions) are scheduled, by the base station, to be in resource block 770, using time-frequency resources 1202, 1204, e.g. two consecutive PUSCH Occasions (POs), and 2 PUSCH transmissions (as part the PUSCH repetition including 4 PUSCH transmissions) are scheduled, by the base station, to be in resource block 772, using time-frequency resources 1206, 1208, e.g. two other consecutive PUSCH occasions (POs). The UE, which receives, e.g. in a RAR message, PUSCH scheduling information, which includes information identifying the four PUSCH Occasions (1202, 1204, 1206, 1208) subsequently transmits the PUSCH signals, e.g., communicating an RRC setup request, on resources 1202, 1204 of the UL BWP 770 of the SBFD slot 720 and on resources 1206, 1208 of the UL BWP 772 of the SBFD slot 722.

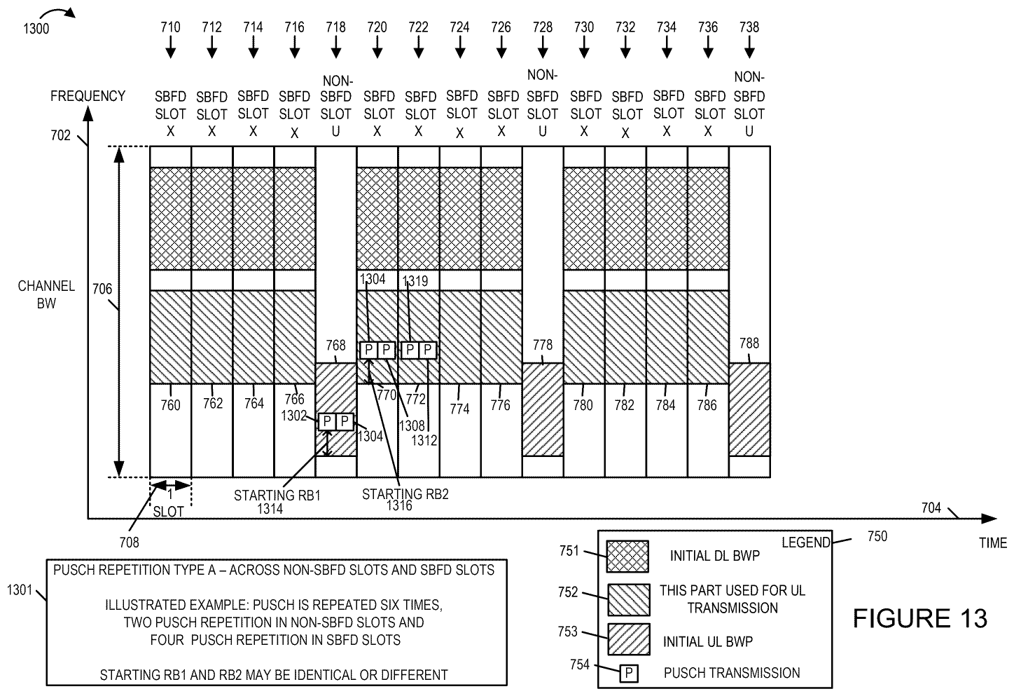

FIG. 13 is a drawing 1300 illustrating an example of a PUSCH repetition type A, in which PUSCH transmission is across non-SBFDs slots and SBFD slots of a timing-frequency structure including SBFD slots and non-SBFD slots, as indicated in information block 1301. In the example of FIG. 13, PUSCH transmission is repeated six times, with two PUSCH signal transmissions, as part of the repetition, in non-SBFD slots and four PUSCH signal transmissions, as part of the repetition, in SBFD slots. Drawing 1300 illustrates an exemplary timing-frequency structure including SBFD slots and non-SBFD slots. Vertical axis 702 represents frequency, while horizontal axis 704 represents time. Frequency range 706 corresponds to an exemplary channel bandwidth (BW) being used by the base station. An exemplary timing slot interval 708 is shown for a first slot, which is slot 710.

FIG. 13 further includes legend 750, which indicates: i) crosshatch shading, as shown in sample block 751, is used to identify an initial downlink (DL) bandwidth part (BWP), ii) left to right descending line shading, as shown in sample block 752, is used to identify parts of the SBFD slots which are to be used for uplink (UL) transmission, iii) left to right ascending line shading, as shown in sample block shading 753, is used to identify an initial UL BWP, and iv) a small block including “P”, as shown in sample 754, is used to identify a PUSCH transmission.

The exemplary timing-frequency structure of drawing 1300 includes: slot 710, which is a SBFD type slot, indicated by designation “X”; slot 712, which is a SBFD type slot, indicated by designation “X”; slot 714, which is a SBFD type slot, indicated by designation “X”; slot 716, which is a SBFD type slot, indicated by designation “X”; slot 718, which a non-SBFD uplink type slot, indicated by designation “U”; slot 720, which is a SBFD type slot, indicated by designation “X”; slot 722, which is a SBFD type slot, indicated by designation “X”; slot 724, which is a SBFD type slot, indicated by designation “X”; slot 726, which is a SBFD type slot, indicated by designation “X”; slot 728, which a non-SBFD uplink type slot, indicated by designation “U”; slot 730, which is a SBFD type slot, indicated by designation “X”; slot 732, which is a SBFD type slot, indicated by designation “X”; slot 734, which is a SBFD type slot, indicated by designation “X”; slot 736, which is a SBFD type slot, indicated by designation “X”; and slot 738, which a non-SBFD uplink type slot, indicated by designation “U”. It may be observed that each of SBFD slots includes a portion which may be used for DL and a portion which may be used for UL.

In this exemplary embodiment, the PUSCH signal repetition can be scheduled for transmission on any of: resource block 760 of SBFD slot 710, resource block 762 of SBFD slot 712, resource block 764 of SBFD slot 714, resource block 766 of SBFD slot 716, resource block 768 of non-SBFD slot 718, resource block 770 of SBFD slot 720, resource block 772 of SBFD slot 722, resource block 774 of SBFD slot 724, resource block 776 of SBFD slot 726, resource block 778 of non-SBFD slot 728, resource block 780 of SBFD slot 730, resource block 782 of SBFD slot 732, resource block 784 of SBFD slot 734, resource block 786 of SBFD slot 736, resource block 788 of non-SBFD slot 738. In this particular example, 2 PUSCH transmissions (as part a PUSCH repetition including 6 PUSCH transmissions) are scheduled, by the base station, to be in resource block 768, using time-frequency resources 1302, 1304, e.g. two consecutive PUSCH Occasions (POs), 2 PUSCH transmissions (as part a PUSCH repetition including 6 PUSCH transmissions) are scheduled, by the base station, to be in resource block 770, using time-frequency resources 1306, 1308, e.g. two consecutive PUSCH Occasions (POs), and 2 PUSCH transmissions (as part the PUSCH repetition including 6 PUSCH transmissions) are scheduled, by the base station, to be in resource block 772, using time-frequency resources 1310, 1312, e.g. two other consecutive PUSCH occasions (POs). The UE, which receives, e.g. in a RAR message, PUSCH scheduling information, which includes information identifying the six PUSCH Occasions (1302, 1304, 1306, 1308, 1310, 1312) subsequently transmits the PUSCH signals, e.g., communicating an RRC setup request, on resources 1302, 1304 of the UL BWP 768 of the non-SBFD slot 718, on resources 1306, 1308 of the UL BWP 770 of the SBFD slot 720 and on resources 1310, 1312 of the UL BWP 772 of the SBFD slot 722.

Starting RB1 1314, which indicates a frequency offset from the lower frequency of UL BWP 768 may be identical or different from RB2 1316, which indicates a frequency offset from the lower frequency of the resource block 770.

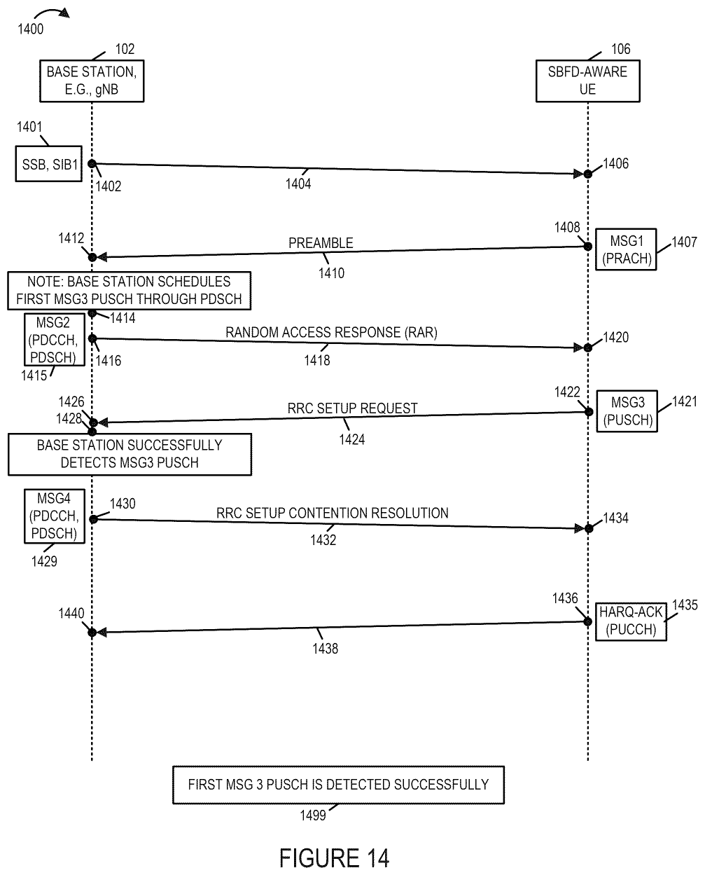

FIG. 14 is a signaling diagram 1400 illustrating a 4-step RACH access method, being performed between exemplary base station 102, e.g., a gNB, and exemplary SBFD-aware UE 106, in accordance with an exemplary embodiment. FIG. 14 is used to illustrate an example, in which a first msg3 PUSCH signal is detected successfully by the base station 102, as indicated by title box 1499.

Information box 1401 indicates that that base station 102 will broadcast Synchronization Signaling Block (SSB) beams conveying System Information Block (SIB) information including System Information Block 1 (SIB1) information. The SIB1 information includes information identifying the timing-frequency structure being implemented by the base station 102, said timing-frequency structure including SBFD slots and non-SBFD slots. In step 1402 base station 102 generates and transmits, e.g., broadcasts, SSB beam(s) 1404 conveying System Information Block Information including SIB1 information. In step 1406, UE 106 detects and receives one or more SSB beams, measures a received signal power, e.g. a DMRS-RSRP corresponding to each of the received SSB beams, identifies a strongest received SSB beam based on RSRP, and recovers the SIB1 information corresponding to the strongest detected SSB.

Information box 1407 indicates that UE 106 will send a message 1 (msg1) using PRACH resources, as part of the 4-step access method. In step 1408 UE 106 generates and sends a msg1 1410 which includes a preamble on RACH Occasion (RO) time-frequency resources of the PRACH, which UE 106 is allowed to use, to base station 102, which receives the PRACH signal communicating msg1 1410 successfully in step 1412 and recovers the communicated information.

In step 1414 base station 102 schedules a first msg3 PUSCH through PDSCH. Information box 1415 indicates that the base station 102 will send a msg2 using PDCCH and PDSCH resources, as part of the 4-step access method. In step 1416, in response to the successfully received PRACH signal from UE 106, base station 102 generates and sends a msg2 PUSCH signal 1418, which communicates a random access response (RAR) message, to UE 106, which receives the RAR message in step 1420 and recovers the communicated information, e.g., information indicating: PUSCH channel resources, e.g., one or more PUSCH occasions (POs), which have been assigned (scheduled) to be used by the UE 106, a PUSCH signal transmission power level, a frequency hopping flag, and a number of repetitions.

Information box 1421 indicates that UE 106 will send a msg3 using PUSCH resources, as part of the 4-step access method. In step 520 UE 106 generates and sends a msg3 PUSCH signal 1424, which communicates a RRC setup request message 522, to base station 102 in accordance with the information in the received RAR, e.g., the UE 106 uses the indicated scheduled time-frequency PUSCH resources to send msg3, transmits msg3 at the indicated transmission power level and sends the indicated number of PUSCH signal repetitions. In step 1426, base station 102 receives the PUSCH signal 1424 communicating the RRC setup request message and recovers the communicated information. Information box 1428 indicates that base station 102 has successfully detected the msg3 PUSCH transmission from UE 106.

Information box 1429 indicates that base station 102 will send a msg4 using PDCCH and PDSCH resources, as part of the 4-step access method. In step 1430 base station 102 generates and sends msg4, which is a RRC setup contention resolution message 1432, to UE 106, which receives the message 1432 in step 1434 and recovers the communicated information.

Information box 1435 indicates that UE 106 will send a HARQ-ACK to base station 102 using PUCCH resources, as part of the 4-step access method. In step 1436 UE 106 generates and sends the HARQ-ACK 1438 to base station 102, which receives the HARQ-ACK 1434 in step 1440.

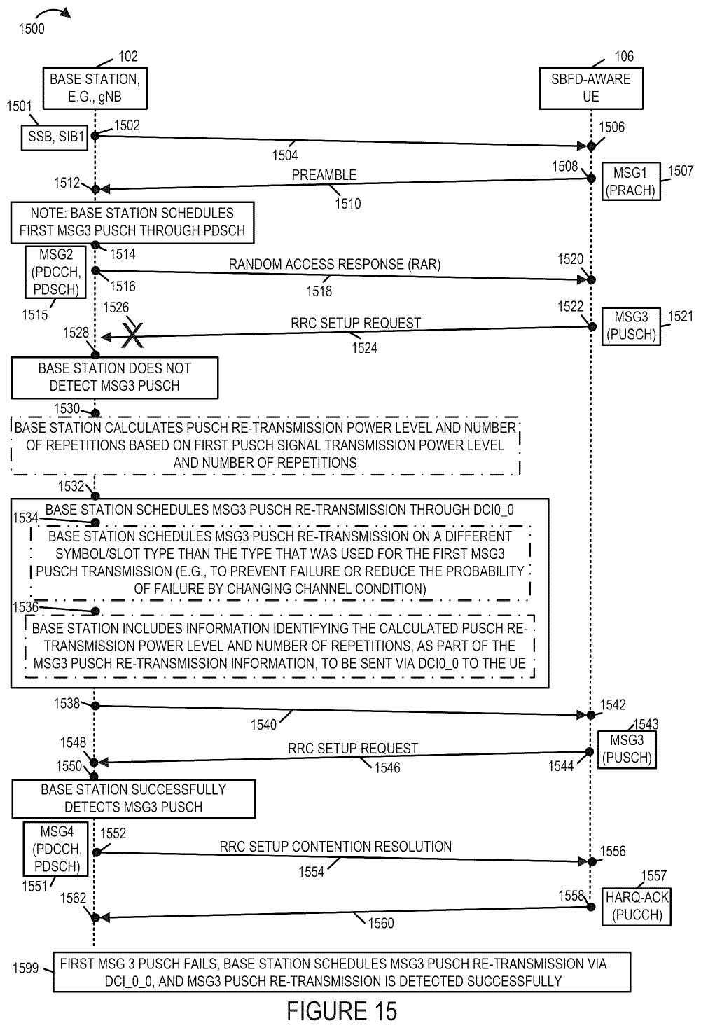

FIG. 15 is a signaling diagram 1500 illustrating a 4-step RACH access method, being performed between exemplary base station 102, e.g., a gNB, and exemplary SBFD-aware UE 106, in accordance with an exemplary embodiment. FIG. 15 is used to illustrate an example, in which a first msg3 PUSCH signal fails, e.g., fails to be detected by the base station 102, and the base station 102 schedules msg3 PUSCH re-transmission via DCI_0_0, and the msg3 PUSCH re-transmission is detected successfully, as indicated by title box 1599.

Information box 1501 indicates that that base station 102 will broadcast Synchronization Signaling Block (SSB) beams conveying System Information Block (SIB) information including System Information Block 1 (SIB1) information. The SIB1 information includes information identifying the timing-frequency structure being implemented by the base station 102, said timing-frequency structure including SBFD slots and non-SBFD slots. In step 1502 base station 102 generates and transmits, e.g., broadcasts, SSB beam(s) 1504 conveying System Information Block Information including SIB1 information. In step 1506, UE 106 detects and receives one or more SSB beams, measures a received signal power, e.g. a DMRS-RSRP corresponding to each of the received SSB beams, identifies a strongest received SSB beam based on RSRP, and recovers the SIB1 information corresponding to the strongest detected SSB.

Information box 1507 indicates that UE 106 will send a message 1 (msg1) using PRACH resources, as part of the 4-step access method. In step 1508 UE 106 generates and sends a msg1 1510 which includes a preamble on RACH Occasion (RO) time-frequency resources of the PRACH, which UE 106 is allowed to use, to base station 102, which receives the PRACH signal communicating msg1 1510 successfully in step 1512 and recovers the communicated information.

In step 1514 base station 102 schedules a first msg3 PUSCH through PDSCH. Information box 1515 indicates that the base station 102 will send a msg2 using PDCCH and PDSCH resources, as part of the 4-step access method. In step 1516, in response to the successfully received PRACH signal from UE 106, base station 102 generates and sends a msg2 PUSCH signal 1518, which communicates a random access response (RAR) message, to UE 106, which receives the RAR message in step 1520 and recovers the communicated information, e.g., information indicating: PUSCH channel resources, e.g., one or more PUSCH occasions (POs), which have been assigned (scheduled) to be used by the UE 106, a PUSCH signal transmission power level, a frequency hopping flag, and a number of repetitions.

Information box 1521 indicates that UE 106 will send a msg3 using PUSCH resources, as part of the 4-step access method. In step 1521 UE 106 generates and transmits a msg3 PUSCH signal 1424, which communicates a RRC setup request message, said PUSCH signal 1424 being directed to base station 102 in accordance with the information in the received RAR, e.g., the UE 106 uses the indicated scheduled time-frequency PUSCH resources to send msg3, transmits msg3 at the indicated transmission power level and sends the indicated number of PUSCH signal repetitions. In this example, the PUSCH signal 1524 conveying the RRC setup request is not successfully received by base station 102, as indicated by X 1526.

Information box 1528 indicates that base station 102 does not detect msg3 PUSCH signal 1524 conveying the RRC setup request from UE 106.

In some embodiments, base station 102 performs step 1530, in which the base station 102 calculates a PUSCH re-transmission power level and number of repetitions based on the first PUSCH transmission power level and number of transmissions.

In step 1532 the base station 102 schedules msg3 PUSCH re-transmission through DCI_0_0. Step 1532 includes step 1534 and in some embodiments, step 1532 further includes step 1536. In step 1534 the base station schedules msg3 PUSCH re-transmission on a different symbol/slot type than the type that was used for the first msg3 PUSCH, e.g., to prevent failure or to reduce the probability of failure by changing the channel conditions. In step 1536 the base station includes information identifying the calculated PUSCH re-transmission power level and number of repetitions, as part of the msg3 PUSCH re-transmission information to be sent via DCI_0_0 to the UE 106.

In step 1538 base station 102 generates and sends signals 1542 communicating DCI_0_0 information including information communicating the PUSCH re-transmission scheduling information, e.g. information corresponding to a second RAR. In step 1524 the UE 106 receives signals 1542 and recovers the communicated information, e.g. information indicating, for a PUSCH re-transmission, :PUSCH channel resources, e.g., one or more PUSCH occasions (POs), which have been assigned (scheduled) to be used by the UE 106, a PUSCH signal transmission power level, a frequency hopping flag, and a number of repetitions.

Information box 1543 indicates that UE 106 will send a msg3 using PUSCH resources, as part of the 4-step access method. In step 1544 UE 106 generates and sends a msg3 PUSCH signal 1546, which communicates a RRC setup request message, said PUSCH signal 1546 being directed to base station 102 in accordance with the information (corresponding to the scheduled PUSCH re-transmission) received in step 1542, e.g., the UE 106 uses the indicated scheduled time-frequency PUSCH resources to send msg3, transmits msg3 at the indicated transmission power level and sends the indicated number of PUSCH signal repetitions. In this example, the PUSCH signal 1546 (which is a PUSCH re-transmission) conveying the RRC setup request is successfully received by base station 102 in step 1548.

Information box 1550 indicates that base station 102 successfully detects msg3 PUSCH of signal 1546.

Information box 1551 indicates that base station 102 will send a msg4 using PDCCH and PDSCH resources, as part of the 4-step access method. In step 1552 base station 102 generates and sends msg4, which is a RRC setup contention resolution message 1554, to UE 106, which receives the message 1554 in step 1556 and recovers the communicated information.

Information box 1557 indicates that UE 106 will send a HARQ-ACK to base station 102 using PUCCH resources, as part of the 4-step access method. In step 1558 UE 106 generates and sends the HARQ-ACK 1560 to base station 102, which receives the HARQ-ACK 1550 in step 1562.

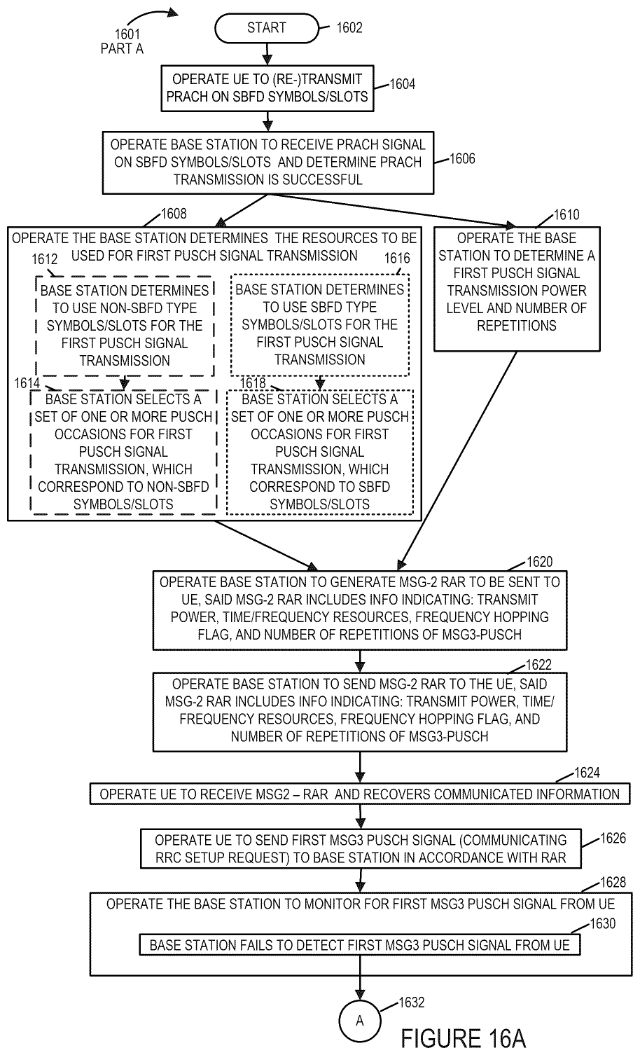

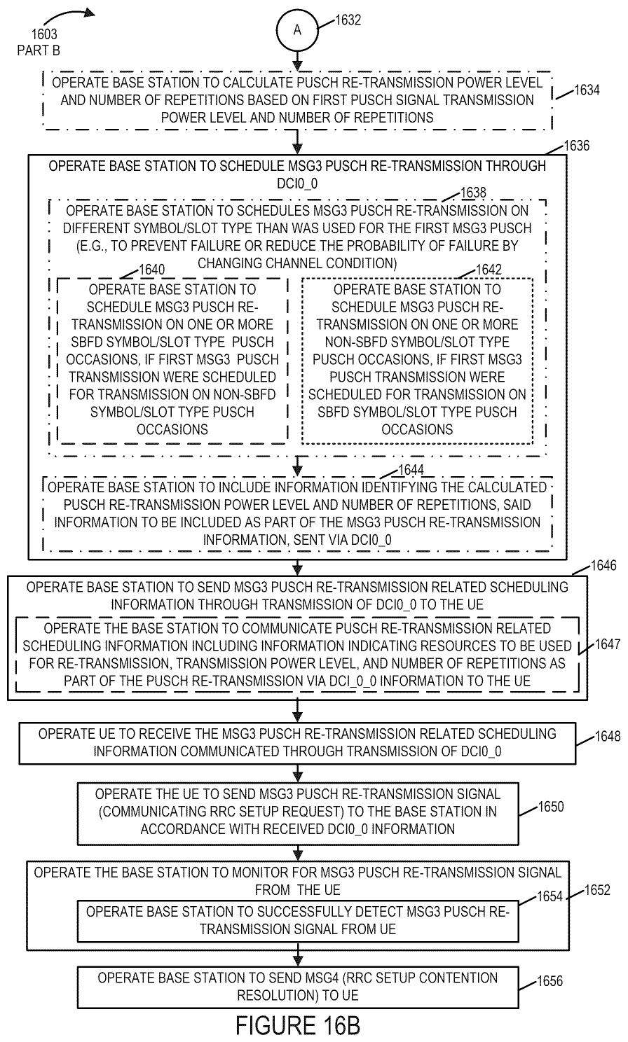

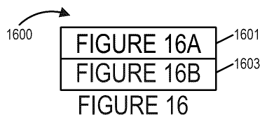

FIG. 16, comprising the combination of FIG. 16A and FIG. 16B, is a flowchart 1600 of an exemplary communications method in accordance with an exemplary embodiment. Operation of the exemplary method starts in step 1602, in which the communications system is powered on and initialized. The exemplary method of flowchart 1000 is, e.g., performed by a base station, e.g., a gNB, and a SBFD-aware UE. The exemplary base station is, e.g., one of base station 1 102 or base station M 104 of system 100 of FIG. 1 and one of the SBFD-aware UE (UE1A 106, UENA 108, UE1C 114, UENC 116) of system 100 of FIG. 1. Operation of the exemplary method starts in step 1002, in which the base station, e.g., BS 1 102, and the SBFD-aware UE, e.g. UE 1A 106, are powered on and initialized. The base station starts transmitting one or more SSB beams. The UE detects at least one Synchronization Signal Block (SSB) beam, measures the received strength of each detected beam, e.g. measures a SSB-RSRP, for each detected beam, identifies a strongest beam, and recovers information corresponding to the strongest detected SSB beam, said recovered information including System Information Block 1 (SIB1) information. In step 1604 the UE is operated to transmit (e.g., for an initial access attempt) or to re-transmit (e.g., for an additional access attempt following failure of the initial access attempt) a PRACH signal including a preamble on SBFD symbols/slots. Operation proceeds from step 1604 to step 1606.

In step 1606 the base station receives the PRACH signal on SBFD symbols/slots and determines that the PRACH transmission was successful. Operation proceeds from step 1606 to step 1608 and step 1610.

In step 1608 the base station determines the resources to be used for a first PUSCH signal transmission. Step 1608 includes steps 1612, 1614, 1616 and 1618. In step 1608, the base station performs either: i) step 1612 and step 1614 or ii) step 1616 and step 1618.

In step 1612 the base station determines to use non-SBFD type symbols/slots for the first PUSCH transmission. Operation proceeds from step 1612 to step 1614, in which the base station selects a set of one or more PUSCH occasions for the first PUSCH signal transmission, which correspond to non-SBFD symbols/slots.

In step 1616 the base station determines to use SBFD type symbols/slots for the first PUSCH transmission. Operation proceeds from step 1616 to step 1618, in which the base station selects a set of one or more PUSCH occasions for the first PUSCH signal transmission, which correspond to SBFD symbols/slots.

Returning to step 1610, in step 1610 the base station determines a first PUSCH signal transmission power level and number of repetitions. Operation proceeds from step 1608 and step 1610 to step 1620.

In step 1620 the base station generates a msg-2 random access response (RAR) to be sent to the UE, said msg-2 RAR includes information indicating: transmit power, time/frequency resources, frequency hopping flag, and number of repetitions of msg-3 PUSCH. Operation proceeds from step 1620 to step 1622, in which the base station sends the generated msg-2 RAR to the UE, said msg-2 RAR includes information indicating: transmit power, time/frequency resources, frequency hopping flag, and number of repetitions of msg-3 PUSCH. Operation proceeds from step 1622 to step 1624, in which the UE receives the msg2-RAR and recovers the communicated information. Operation proceeds from step 1624 to step 1626.

In step 1626, the UE sends a first msg3 PUSCH signal, communicating a RRC setup request, to the base station in accordance with the RAR. Operation proceeds from step 1626 to step 1628, in which the base station monitors for first msg3 PUSCH signal from the UE.

In this example, step 1628, includes step 1630, in which the base station fails to detect the first msg3 PUSCH signal from the UE. In some embodiments, operation proceeds from step 1630, via connecting node A 1632, to step 1634 of FIG. 16B. In some other embodiments, operation proceeds from step 1630, via connecting node A 1632, to step 1636 of FIG. 16B, which bypasses step 1634.

Returning to step 1634, in step 1634 the base station calculates a PUSCH re-transmission power level and number of repetitions based on the first PUSCH transmission power level and number of repetitions. Operation proceeds from step 1634 to step 1636.

In step 1636 the base station schedules msg3 PUSCH re-transmission through a Downlink Control Information communication (DCI0_0). In some embodiments, step 1630 includes step 1638. In some embodiments, e.g., an embodiment including step 1634, step 1630 includes step 1644.

In step 1638 the base station schedules msg3 PUSCH re-transmission on different symbol/slot type than the symbol/slot type which is used for the first msg3 PUSCH transmission, e.g., to prevent failure or reduce the probability of failure by changing the channel conditions. Step 1638 includes step 1640 and step 1642, one of which is performed for an iteration of step 1638.

In step 1640 the base station schedules msg3 PUSCH re-transmission on or more SBFD symbol/slot type PUSCH occasions, if the first msg3 PUSCH transmission was scheduled for transmission on non-SBFD symbol/slot type PUSCH occasions. Alternatively, in step 1642 the base station schedules msg3 PUSCH re-transmission on or more non-SBFD symbol/slot type PUSCH occasions, if the first msg3 PUSCH transmission was scheduled for transmission on SBFD symbol/slot type PUSCH occasions.

In step 1644 the base station includes information identifying the calculated PUSCH retransmission power level and number of repetitions, from step 1634, in the msg3-PUSCH re-transmission information to be sent via DCI_0_0.

Operation proceeds from step 1636 to step 1646, in which the base station sends msg3 PUSCH re-transmission related scheduling information through transmission of DCI_0_0 to the UE. In some embodiments, step 1646 includes step 1647, in which the base station communicates PUSCH re-transmission related scheduling information including information indicating resources to be used for re-transmission, transmission power level and number of repetitions as part of the PUSCH re-transmission via DCI_0_0 information to the UE. Operation proceeds from step 1646 to step 1648, in which the UE receives the msg3 PUSCH related scheduling information through transmission of DCI0_0. Operation proceeds from step 1648 to step 1650.

In step 1650 the UE sends msg3 PUSCH re-transmission signals (communicating a RRC setup request) to the base station in accordance with the received DCI0_0 information, e.g., using the allocated POs, at the specified transmission power level and with the specified number of repetitions.

In step 1652 the base station is operated to monitor for msg3 PUSCH re-transmission from the UE. In this example, step 1652 includes step 1654, in which the base station successfully detects msg3 PUSCH re-transmission signal from the UE. Operation proceeds from step 1654 to step 1656, in which the base station send a msg4 (RRC setup contention resolution) to the UE.

### First Numbered List of Exemplary Method Embodiments

[Method Embodiment Set 1—BS Method Embodiments relating to FIG. 6—receive PRACH signal and allocates resources for PUSCH with resources being SBFD or non-SBFD resources with selected resources for UE being indicated in RAR message—PUSCH signal repetitions are supported (in dependent Method Embodiments) and the number or repetitions indicated to the UE.]
Method Embodiment 1. A method of operating a base station, the method comprising: receiving (610) a PRACH signal on SBFD slot resources (e.g., symbols) from a first UE (e.g. an SBFD capable UE as indicated by the use of SBFD slot resources to communicate the PRACH signal); selecting (614) (e.g., determine) resources to be used by the first UE for PUSCH signaling by selecting between use of SBFD resources and non-SBFD resources based on at least one of: i) resource availability (616), ii) latency (618), iii) a transmit power level to be used (e.g., required) for UE PUSCH transmission (620) by the first UE, or iv) the resource type (622) of a received signal whose power is used to control the transmit power level to be used for UE PUSCH transmission by the first UE; and transmitting (646) a random access response (RAR) message to the first UE indicating PUSCH resources allocated to the first UE for PUSCH signaling, said resources being said selected resources to be used by the first UE for PUSCH signaling.
Method Embodiment 2. The method of Method Embodiment 1, wherein selecting (614) resources to be used by the first UE for PUSCH signaling by selecting between use of SBFD resources and non-SBFD resources is based on resource availability (616), said step of selecting (614) resources to be used including: determining (624) if there are enough PUSCH resources available in SBFD slots for the first UE.
Method Embodiment 3. The method of Method Embodiment 2, further comprising: selecting (626) PUSCH resources (e.g., symbols) of SBFD slots for the first UE to use to transmit PUSCH signals in response to determining that are enough PUSCH resources available in SBFD slots for the first UE.
Method Embodiment 4. The method of Method Embodiment 2, further comprising: selecting (628) PUSCH resources (e.g., symbols) of non-SBFD slots for the first UE to use to transmit PUSCH signals in response to determining that are not enough PUSCH resources available in SBFD slots for the first UE to transmit PUSCH signals.
Method Embodiment 5. The method of Method Embodiment 1, wherein selecting (614) resources to be used by the first UE for PUSCH signaling by selecting between use of SBFD resources and non-SBFD resources is based on latency (618), said step of determining (614) resources to be used, including: determining (630) if transmission of PUSCH signals by the first UE using SBFD resources will result in lower latency than using non-SBFD resources; and selecting (632) SBFD resources to be used by the first UE when use of SBFD resources will result in a lower PUSCH signal latency for the first UE than using non-SBFD resources.
Method Embodiment 6. The method of Method Embodiment 5, wherein selecting (614) resources to be used by the first UE for PUSCH signaling includes: selecting (634) non-SBFD resources to be used by the first UE when use of SBFD resources will not result in a lower PUSCH signal latency for the first UE than using non-SBFD resources.
Method Embodiment 7. The method of Method Embodiment 1, wherein selecting (614) resources to be used by the first UE for PUSCH signaling by selecting between use of SBFD resources and non-SBFD resources is based on the transmit power level required for UE PUSCH transmission by the first UE, said step of selecting (614) resources to be used including: determining (636) if the power level required for UE PUSCH transmission of PUSCH signals by the first UE is above a predetermined power level threshold (e.g., a power level threshold corresponding to 80% of the maximum PUSCH transmission power level which is close to (e.g., within 20% of) the PUSCH max transmission power level); and selecting (638) non-SBFD resources to be used by the first UE for PUSCH signaling in response to determining that the power level required for UE PUSCH transmission of PUSCH signals is over the predetermined power level threshold.
Method Embodiment 8. The method of Method Embodiment 7, wherein said selecting (614) resources to be used by the first UE for PUSCH signaling includes: selecting (640) SBFD resources to be used by the first UE for PUSCH signaling in response to determining that the power level required for UE PUSCH transmission of PUSCH signals is not over the predetermined power level threshold.
Method Embodiment 9. The method of Method Embodiment 1, wherein selecting (614) resources to be used by the first UE for PUSCH signaling by selecting between use of SBFD resources and non-SBFD resources is based on the resource type (622) of a received signal whose received power is used to control the transmit power level to be used for UE PUSCH transmission by the first UE; wherein the received signal whose received power is used to control the transmit power level to be used for UE PUSCH transmission by the first UE is said received PRACH signal from the first UE; and wherein selecting (614) resources to be used by the first UE for PUSCH signaling includes selecting (642) SBFD resources in response to the PRACH signal from the first UE being received on SBFD resources.

Method Embodiment 10 relates to selecting resources for PUSCH which include repetitions—e.g. select resources to minimize latency (see FIG. 6 step 6232) and don't require PUSCH repetitions to be on same type of resources as first PUSCH signal transmission by UE.
Method Embodiment 10. The method of Method Embodiment 1, wherein selecting (614) resources to be used by the first UE for PUSCH signaling by selecting between use of SBFD resources and non-SBFD resources includes selecting resources to be indicated in a random access response (RAR) message for repetition of PUSCH signals transmitted by the UE using different slots; and wherein said selecting (614) (e.g., determining) resources to be used by the first UE for PUSCH signaling by selecting between use of SBFD resources and non-SBFD resources based on at least one of: i) resource availability (616), ii) latency (618), iii) a transmit power level to be used (e.g., required) for UE PUSCH transmission (620) by the first UE, or iv) the resource type (622) of a received signal whose power is used to control the transmit power level to be used for UE PUSCH transmission by the first UE was to select resources for a first PUSCH transmission; and wherein the method further comprises: selecting (6232) resources to be used by the first UE for PUSCH signaling repetitions based on resource availability with both non-SBFD and SBFD resources (e.g., slots and/or symbols) being selected for repetitions to minimize latency irrespective of whether an SBFD or non-SBFD resource was selected for the first PUSCH transmission.

Method Embodiment 11 relates to selecting resources for PUSCH which include repetitions—e.g. select resources so that transmission power level information based on received PRACH signal can be used for power control of the initial PUSH and repetition and doesn't require PUSCH repetitions to be on same type of resources as first PUSCH signal transmission by UE.
Method Embodiment 11. The method of Method Embodiment 1, wherein selecting (614) (e.g., determine) resources to be used by the first UE for PUSCH signaling by selecting between use of SBFD resources and non-SBFD resources includes selecting resources to be indicated in a random access response (RAR) message for repetition of PUSCH signals transmitted by the UE using different slots; and wherein said selecting (614) (e.g., determine) resources to be used by the first UE for PUSCH signaling by selecting between use of SBFD resources and non-SBFD resources based on at least one of: i) resource availability (616), ii) latency (618), iii) a transmit power level to be used (e.g., required) for UE PUSCH transmission (620) by the first UE, or iv) the resource type (622) of a received signal whose power is used to control the transmit power level to be used for UE PUSCH transmission by the first UE was to select resources for a first PUSCH transmission; and wherein the method further comprises: selecting (6231) resources to be used by the first UE for PUSCH signaling repetitions which are of the same type selected for the first PUSCH signal, said type being and SBFD type of resources or non-SBFD resources (this allows in some embodiments, the same transmission power control based on a received signal to be used all the resources used for PUSCH signaling since the resources will be of a consistent type, e.g., SBFD resources will be used in some embodiments for both the initial and repeat PUSCH repetitions when the PRACH signal to which the PUSCH resource grant corresponds was received on an SBFD resource with the received PRACH signal power being used in controlling the PUSCH transmission power level which will be signaled to the UE to be used).

### Apparatus Embodiment Set 1

At least some of these BS (apparatus) embodiments relate to FIG. 6 in which a BS receives a PRACH signal and allocates resources for PUSCH with resources being SBFD or non-SBFD resources with selected resources for a UE being indicated in a RAR message with PUSCH signal repetitions being supported in some embodiments in which the and the number of repetitions is indicated to the UE.
Apparatus Embodiment 1. A base station (102 or 104 or 200) comprising: a wireless receiver (218); a wireless transmitter (220); and a processor (202) configured to:
control the base station to receive (610) (via wireless receiver (218)) a PRACH signal on SBFD slot resources (e.g., symbols) from a first UE (e.g. an SBFD capable UE as indicated by the use of SBFD slot resources to communicate the PRACH signal); select (614) (e.g., determine) resources to be used by the first UE for PUSCH signaling by selecting between use of SBFD resources and non-SBFD resources based on at least one of: i) resource availability (616), ii) latency (618), iii) a transmit power level to be used (e.g., required) for UE PUSCH transmission (620) by the first UE, or iv) the resource type (622) of a received signal whose power is used to control the transmit power level to be used for UE PUSCH transmission by the first UE; and control the base station to transmit (646) (via wireless transmitter (220) a random access response (RAR) message to the first UE indicating PUSCH resources allocated to the first UE for PUSCH signaling, said resources being said selected resources to be used by the first UE for PUSCH signaling.
Apparatus Embodiment 2. The base station of Apparatus Embodiment 1, wherein said processor (202) is configured to: select (614) resources to be used by the first UE for PUSCH signaling by selecting between use of SBFD resources and non-SBFD resources based on resource availability (616); and wherein said processor (202) is configured to determine (624) if there are enough PUSCH resources available in SBFD slots for the first UE, as part of being configured to select (614) resources to be used.
Apparatus Embodiment 3. The base station of Apparatus Embodiment 2, wherein said processor (202) is configured to: select (626) PUSCH resources (e.g., symbols or a PUSCH occasion) of SBFD slots for the first UE to use to transmit PUSCH signals in response to determining that are enough PUSCH resources available in SBFD slots for the first UE.
Apparatus Embodiment 4. The base station of Apparatus Embodiment 2, wherein said processor (202) is configured to: select (628) PUSCH resources (e.g., symbols or PUSCH occasion) of non-SBFD slots for the first UE to use to transmit PUSCH signals in response to determining that are not enough PUSCH resources available in SBFD slots for the first UE to transmit PUSCH signals.
Apparatus Embodiment 5. The base station of Apparatus Embodiment 1, wherein said processor (202) is configured to select (614) resources to be used by the first UE for PUSCH signaling by selecting between use of SBFD resources and non-SBFD resources based on latency (618); and said processor (202) is configured to: determine (630) if transmission of PUSCH signals by the first UE using SBFD resources will result in lower latency than using non-SBFD resources; and select (632) SBFD resources to be used by the first UE when use of SBFD resources will result in a lower PUSCH signal latency for the first UE than using non-SBFD resources, as part of being configured to select (614) resources to be used by the first UE for PUSCH signaling.
Apparatus Embodiment 6. The base station of Apparatus Embodiment 5, wherein said processor (202) is configured to: select (634) non-SBFD resources to be used by the first UE when use of SBFD resources will not result in a lower PUSCH signal latency for the first UE than using non-SBFD resources, as part of being configured to select (614) resources to be used by the first UE for PUSCH signaling.
Apparatus Embodiment 7. The base station of Apparatus Embodiment 1, wherein said processor (202) is configured to select (614) resources to be used by the first UE for PUSCH signaling by selecting between use of SBFD resources and non-SBFD resources based on the transmit power level required for UE PUSCH transmission by the first UE; and wherein said processor (202) is configured to: determine (636) if the power level required for UE PUSCH transmission of PUSCH signals by the first UE is above a predetermined power level threshold (e.g., a power level threshold corresponding to 80% of the maximum PUSCH transmission power level which is close to (e.g., within 20% of) the PUSCH max transmission power level); and select (638) non-SBFD resources to be used by the first UE for PUSCH signaling in response to determining that the power level required for UE PUSCH transmission of PUSCH signals is over the predetermined power level threshold, as part of being configured to select (614) resources to be used.
Apparatus Embodiment 8. The base station of Apparatus Embodiment 7, wherein said processor (202) is configured to: select (640) SBFD resources to be used by the first UE for PUSCH signaling in response to determining that the power level required for UE PUSCH transmission of PUSCH signals is not over the predetermined power level threshold, as part of being configured to select (614) resources to be used by the first UE for PUSCH signaling.
Apparatus Embodiment 9. The base station of Apparatus Embodiment 1, wherein said processor (202) is configured to select (614) resources to be used by the first UE for PUSCH signaling by selecting between use of SBFD resources and non-SBFD resources based on the resource type (622) of a received signal whose received power is used to control the transmit power level to be used for UE PUSCH transmission by the first UE; wherein the received signal whose received power is used to control the transmit power level to be used for UE PUSCH transmission by the first UE is said received PRACH signal from the first UE; and wherein said processor (202) is configured to select (642) SBFD resources in response to the PRACH signal from the first UE being received on SBFD resources, as part of being configured to select (614) resources to be used by the first UE for PUSCH signaling.

Apparatus Embodiment 10 relates to selecting resources for PUSCH which include repetitions—e.g. select resources to minimize latency (see FIG. 6 step 6232) and without a requirement that PUSCH repetitions be on the same type of resources as the first PUSCH signal transmission by UE.
Apparatus Embodiment 10. The base station of Apparatus Embodiment 1, wherein said processor (202) is configured to: select resources to be indicated in a random access response (RAR) message for repetition of PUSCH signals transmitted by the UE using different slots, as part of being configured to: select (614) resources to be used by the first UE for PUSCH signaling by selecting between use of SBFD resources and non-SBFD resources includes; and wherein said selecting (614) (e.g., determining) resources to be used by the first UE for PUSCH signaling by selecting between use of SBFD resources and non-SBFD resources based on at least one of: i) resource availability (616), ii) latency (618), iii) a transmit power level to be used (e.g., required) for UE PUSCH transmission (620) by the first UE, or iv) the resource type (622) of a received signal whose power is used to control the transmit power level to be used for UE PUSCH transmission by the first UE was to select resources for a first PUSCH transmission; and wherein the processor (202) is further configured to: select (6232) resources to be used by the first UE for PUSCH signaling repetitions based on resource availability with both non-SBFD and SBFD resources (e.g., slots and/or symbols) being selected for repetitions to minimize latency irrespective of whether an SBFD or non-SBFD resource was selected for the first PUSCH transmission.

Apparatus Embodiment 11 relates to selecting resources for PUSCH which include repetitions—e.g. select resources so that transmission power level information based on received PRACH signal can be used for power control of the initial PUSH and repetition and doesn't require PUSCH repetitions to be on same type of resources as first PUSCH signal transmission by UE).
Apparatus Embodiment 11. The base station of Apparatus Embodiment 1, wherein said processor (202) is configured to: select resources to be indicated in a random access response (RAR) message for repetition of PUSCH signals transmitted by the UE using different slots, as part of being configured to: selecting (614) (e.g., determine) resources to be used by the first UE for PUSCH signaling by selecting between use of SBFD resources and non-SBFD resources; and wherein said selecting (614) (e.g., determining) resources to be used by the first UE for PUSCH signaling by selecting between use of SBFD resources and non-SBFD resources based on at least one of: i) resource availability (616), ii) latency (618), iii) a transmit power level to be used (e.g., required) for UE PUSCH transmission (620) by the first UE, or iv) the resource type (622) of a received signal whose power is used to control the transmit power level to be used for UE PUSCH transmission by the first UE was to select resources for a first PUSCH transmission; and wherein said processor (202) is further configured to: select (6231) resources to be used by the first UE for PUSCH signaling repetitions which are of the same type selected for the first PUSCH signal, said type being and SBFD type of resources or non-SBFD resources (this allows in some embodiments, the same transmission power control based on a received signal to be used all the resources used for PUSCH signaling since the resources will be of a consistent type, e.g., SBFD resources will be used in some embodiments for both the initial and repeat PUSCH repetitions when the PRACH signal to which the PUSCH resource grant corresponds was received on an SBFD resource with the received PRACH signal power being used in controlling the PUSCH transmission power level which will be signaled to the UE to be used).

The following Method Embodiments relate to FIG. 16 and Failure to detect a MSG 3 PUSCH signal from a UE following a PRACH signal success.

### Second Numbered List of Exemplary Method Embodiments

Method Embodiment 1. A method of operating a base station, the method comprising: receiving (1606) a PRACH signal from a first UE; sending (1622) a random access response (RAR) message to the first UE indicating resources to be used by the first UE for transmitting a PUSCH signal, said resources being first type of resource, said first type of resource being one of i) a SBFD resource or ii) a non-SBFD resource; failing (1630) to detect a PUSCH signal from the first UE on the indicated resources to be used by the first UE for transmitting a PUSCH signal; scheduling (1638) PUSCH re-transmission for the first UE on resources which are of a different type than the first type resources; and sending (1646) PUSCH re-transmission scheduling information to the first UE.
Method Embodiment 2. The method of Method Embodiment 1, wherein the PUSCH re-transmission scheduling information, which is sent to the UE is communicated via Downlink Control Information (DCI) (e.g., a DCI_0_0 information).
Method Embodiment 3. The method of Method Embodiment 1, wherein the first type of resource is an SBFD resource and the second type resource is a non-SBFD resource.
Method Embodiment 4. The method of Method Embodiment 1, wherein the first type resource is a non-SBFD resource and the second type resource is an SBFD resource.
Method Embodiment 5. The method of Method Embodiment 1, further comprising: calculating (1634) a PUSCH re-transmission power level and a number of PUSCH signal repetitions to be used by the UE as part of the scheduled PUSCH re-transmission.
Method Embodiment 6. The method of Method Embodiment 5, wherein sending (1646) PUSCH re-transmission scheduling information to the first UE includes: communicating (1647) the re-transmission information including information indicating resources to be used for re-transmission, transmission power level and the number of repetitions to be performed as part of the PUSCH re-transmission via Downlink Control Information (DCI) (e.g., DCI0_0 information) communicated to the first UE.
Method Embodiment 7. The method of Method Embodiment 5, wherein calculating (1634) the PUSCH re-transmission power level included calculating a re-transmission power level that is different from a transmission power level that was to be used for the PUSCH signal that was not detected (e.g., a power level that the base station indicated to the first UE that was to be used for the first PUSCH signal which failed to be detected by the base station).
Method Embodiment 8. The method of Method Embodiment 5, wherein calculating (1634) number of PUSCH signal repetitions to be used by the UE as part of the scheduled PUSCH re-transmission includes calculating a larger number of repetitions than was scheduled to be used by the first UE for the PUSCH transmission which failed to be detected by the base station.
Method Embodiment 9. The method of Method Embodiment 5, wherein calculating (1634) the PUSCH re-transmission power level and number of repetitions to be used by the UE as part of the scheduled PUSCH re-transmission includes calculating a higher transmission power level and higher number of repetitions than was to be used for the PUSCH transmission that failed to be received.
Method Embodiment 10. The method of Method Embodiment 9, further comprising: operating the base station to successfully receive (1654) (e.g., detect) a PUSCH re-transmission from the UE communicated on resources corresponding to the scheduled PUSCH re-transmission.

The following numbered Apparatus Embodiments relate to FIG. 16 and Failure to detect a MSG 3 PUSCH signal from a UE following a PRACH signal success.

### Second Numbered List of Exemplary Apparatus Embodiments

Apparatus Embodiment 1. A base station (102 or 104 or 200) comprising: a wireless receiver (218); a wireless transmitter (220); and a processor (202) configured to control the base station to: receive (1606) (via the wireless receiver (218)) a PRACH signal from a first UE (106 or 108 or 114 or 116); send (1622) (via the wireless transmitter (220)) a random access response (RAR) message to the first UE indicating resources to be used by the first UE for transmitting a PUSCH signal, said resources being first type of resource, said first type of resource being one of i) a SBFD resource or ii) a non-SBFD resource; determine that an expected PUSCH signal from the first UE on the indicated resources to be used by the first UE for transmitting a PUSCH signal has not been detected; schedule (1638) PUSCH re-transmission for the first UE on resources which are of a different type than the first type resources; and send (1646) (via the wireless transmitter (220) PUSCH re-transmission scheduling information to the first UE.
Apparatus Embodiment 2. The base station of Apparatus Embodiment 1, wherein the PUSCH re-transmission scheduling information, which is sent to the UE is communicated via Downlink Control Information (DCI) (e.g., a DCI_0_0 information).
Apparatus Embodiment 3. The base station of Apparatus Embodiment 1, wherein the first type of resource is an SBFD resource and the second type resource is a non-SBFD resource.
Apparatus Embodiment 4. The base station of Apparatus Embodiment 1, wherein the first type resource is a non-SBFD resource and the second type resource is an SBFD resource.
Apparatus Embodiment 5. The base station of Apparatus Embodiment 1, wherein said processor is further configured to control the base station to: calculate (1634) a PUSCH re-transmission power level and a number of PUSCH signal repetitions to be used by the UE as part of the scheduled PUSCH re-transmission.
Apparatus Embodiment 6. The base station of Apparatus Embodiment 5, wherein said processor (202) is configured to control the base station to: communicate (1647) the re-transmission information including information indicating resources to be used for re-transmission, transmission power level and the number of repetitions to be performed as part of the PUSCH re-transmission via Downlink Control Information (DCI) (e.g., DCI0_0 information) communicated to the first UE, as part of being configured to control the base station to send (1646) PUSCH re-transmission scheduling information to the first UE.
Apparatus Embodiment 7. The base station of Apparatus Embodiment 5, wherein said processor (202) is configured to control the base station to calculate a re-transmission power level that is different from a transmission power level that was to be used for the PUSCH signal that was not detected (e.g., a power level that the base station indicated to the first UE that was to be used for the first PUSCH signal which failed to be detected by the base station), as part of being configured to control the base station to calculate (1634) the PUSCH re-transmission power level.
Apparatus Embodiment 8. The base station of Apparatus Embodiment 5, wherein said processor (202) is configured to control the base station to calculate a larger number of repetitions than was scheduled to be used by the first UE for the PUSCH transmission which failed to be detected by the base station, as part of being configured to control the base station to calculate (1634) number of PUSCH signal repetitions to be used by the UE as part of the scheduled PUSCH re-transmission.
Apparatus Embodiment 9. The base station of Apparatus Embodiment 5, wherein said processor (202) is configured to control the base station to calculate a higher transmission power level and higher number of repetitions than was to be used for the PUSCH transmission that failed to be received, as part of being configured to control the base station to calculate (1634) the PUSCH re-transmission power level and number of repetitions to be used by the UE as part of the scheduled PUSCH re-transmission.
Apparatus Embodiment 10. The base station of Apparatus Embodiment 9, wherein said processor (202) is further configured to control the base station to successfully receive (1654) (via the wireless receiver (218)) (e.g., detect) a PUSCH re-transmission from the UE communicated on resources corresponding to the scheduled PUSCH re-transmission.

The techniques of various embodiments may be implemented using software, hardware and/or a combination of software and hardware. Various embodiments are directed to apparatus, e.g., base stations, user equipment (UE) devices, core network devices (e.g., PCF devices, AMF devices, SMF devices, UPF devices, UDM devices, UDR devices, AUSF devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating base stations, user equipment (UE) devices, core network devices (e.g., PCF devices, AMF devices, SMF devices, UPF devices, AUSF devices, UDM devices, UDR devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., base stations, user equipment (UE) devices, core network devices (e.g., PCF devices, AMF devices, SMF devices, UPF devices, UDM devices, UDR devices, AUSF devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning and/or configuring user equipment devices, provisioning and/or configuring AP devices, provisioning AAA servers, provisioning orchestration servers, generating messages, message reception, message transmission, signal processing, sending, comparing, determining and/or transmission steps. Thus, in some embodiments various features are implemented using components, or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., base stations, user (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the base stations, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, node and/or element, with a processor which includes a component corresponding to each of the steps of the various described methods performed by the device in which the processor is included. In some but not all embodiments a device, e.g., a base station, a user equipment (UE) device, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, nodes and/or element. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a base station, the method comprising:
receiving a physical random access channel (PRACH) signal on sub-band full duplex (SBFD) slot resources from a first user equipment (UE);
selecting resources to be used by the first UE for physical uplink shared channel (PUSCH) signaling by selecting between use of SBFD resources and non-SBFD resources based on at least one of: i) resource availability, ii) latency, iii) a transmit power level to be used for UE PUSCH transmission by the first UE, or iv) the resource type of a received signal whose power is used to control the transmit power level to be used for UE PUSCH transmission by the first UE; and
transmitting a random access response (RAR) message to the first UE indicating PUSCH resources allocated to the first UE for PUSCH signaling, said resources being said selected resources to be used by the first UE for PUSCH signaling.

2. The method of claim 1, wherein selecting resources to be used by the first UE for PUSCH signaling by selecting between use of SBFD resources and non-SBFD resources is based on resource availability, said step of selecting resources to be used including:
determining if there are enough PUSCH resources available in SBFD slots for the first UE.

3. The method of claim 2, further comprising:
selecting PUSCH resources of SBFD slots for the first UE to use to transmit PUSCH signals in response to determining that are enough PUSCH resources available in SBFD slots for the first UE.

4. The method of claim 2, further comprising:
selecting PUSCH resources of non-SBFD slots for the first UE to use to transmit PUSCH signals in response to determining that are not enough PUSCH resources available in SBFD slots for the first UE to transmit PUSCH signals.

5. The method of claim 1, wherein selecting resources to be used by the first UE for PUSCH signaling by selecting between use of SBFD resources and non-SBFD resources is based on latency, said step of determining resources to be used, including:
determining if transmission of PUSCH signals by the first UE using SBFD resources will result in lower latency than using non-SBFD resources; and
selecting SBFD resources to be used by the first UE when use of SBFD resources will result in a lower PUSCH signal latency for the first UE than using non-SBFD resources.

6. The method of claim 5, wherein selecting resources to be used by the first UE for PUSCH signaling includes:
selecting non-SBFD resources to be used by the first UE when use of SBFD resources will not result in a lower PUSCH signal latency for the first UE than using non-SBFD resources.

7. The method of claim 1, wherein selecting resources to be used by the first UE for PUSCH signaling by selecting between use of SBFD resources and non-SBFD resources is based on the transmit power level required for UE PUSCH transmission by the first UE, said step of selecting resources to be used including:
determining if the power level required for UE PUSCH transmission of PUSCH signals by the first UE is above a predetermined power level threshold; and
selecting non-SBFD resources to be used by the first UE for PUSCH signaling in response to determining that the power level required for UE PUSCH transmission of PUSCH signals is over the predetermined power level threshold.

8. The method of claim 1,
wherein selecting resources to be used by the first UE for PUSCH signaling by selecting between use of SBFD resources and non-SBFD resources is based on the resource type of a received signal whose received power is used to control the transmit power level to be used for UE PUSCH transmission by the first UE;
wherein the received signal whose received power is used to control the transmit power level to be used for UE PUSCH transmission by the first UE is said received PRACH signal from the first UE; and
wherein selecting resources to be used by the first UE for PUSCH signaling includes selecting SBFD resources in response to the PRACH signal from the first UE being received on SBFD resources.

9. The method of claim 1,
wherein selecting resources to be used by the first UE for PUSCH signaling by selecting between use of SBFD resources and non-SBFD resources includes selecting resources to be indicated in a random access response (RAR) message for repetition of PUSCH signals transmitted by the UE using different slots; and
wherein said selecting resources to be used by the first UE for PUSCH signaling by selecting between use of SBFD resources and non-SBFD resources based on at least one of: i) resource availability, ii) latency, iii) a transmit power level to be used for UE PUSCH transmission by the first UE, or iv) the resource type of a received signal whose power is used to control the transmit power level to be used for UE PUSCH transmission by the first UE was to select resources for a first PUSCH transmission; and
wherein the method further comprises:
selecting resources to be used by the first UE for PUSCH signaling repetitions based on resource availability with both non-SBFD and SBFD resources being selected for repetitions to minimize latency irrespective of whether an SBFD or non-SBFD resource was selected for the first PUSCH transmission.

10. The method of claim 1,
wherein selecting resources to be used by the first UE for PUSCH signaling by selecting between use of SBFD resources and non-SBFD resources includes selecting resources to be indicated in a random access response (RAR) message for repetition of PUSCH signals transmitted by the UE using different slots; and
wherein said selecting resources to be used by the first UE for PUSCH signaling by selecting between use of SBFD resources and non-SBFD resources based on at least one of: i) resource availability, ii) latency, iii) a transmit power level to be used for UE PUSCH transmission by the first UE, or iv) the resource type of a received signal whose power is used to control the transmit power level to be used for UE PUSCH transmission by the first UE was to select resources for a first PUSCH transmission; and
wherein the method further comprises:
selecting resources to be used by the first UE for PUSCH signaling repetitions which are of the same type selected for the first PUSCH signal, said type being and SBFD type of resources or non-SBFD resources.

11. A base station comprising:
a wireless receiver;
a wireless transmitter; and
a processor configured to:
control the base station to receive a physical random access channel (PRACH) signal on sub-band full duplex (SBFD) slot resources from a first UE;
select resources to be used by the first UE for physical uplink shared channel (PUSCH) signaling by selecting between use of SBFD resources and non-SBFD resources based on at least one of: i) resource availability, ii) latency, iii) a transmit power level to be used for UE PUSCH transmission by the first UE, or iv) the resource type of a received signal whose power is used to control the transmit power level to be used for UE PUSCH transmission by the first UE; and
control the base station to transmit a random access response (RAR) message to the first UE indicating PUSCH resources allocated to the first UE for PUSCH signaling, said resources being said selected resources to be used by the first UE for PUSCH signaling.

12. The base station of claim 11, wherein said processor is configured to: select resources to be used by the first UE for PUSCH signaling by selecting between use of SBFD resources and non-SBFD resources based on resource availability; and
wherein said processor is configured to determine if there are enough PUSCH resources available in SBFD slots for the first UE, as part of being configured to select resources to be used.

13. The base station of claim 11, wherein said processor is configured to select resources to be used by the first UE for PUSCH signaling by selecting between use of SBFD resources and non-SBFD resources based on latency; and
wherein said processor is configured to:
determine if transmission of PUSCH signals by the first UE using SBFD resources will result in lower latency than using non-SBFD resources; and
select SBFD resources to be used by the first UE when use of SBFD resources will result in a lower PUSCH signal latency for the first UE than using non-SBFD resources,
as part of being configured to select resources to be used by the first UE for PUSCH signaling.

14. The base station of claim 11, wherein said processor is configured to select resources to be used by the first UE for PUSCH signaling by selecting between use of SBFD resources and non-SBFD resources based on the transmit power level required for UE PUSCH transmission by the first UE; and
wherein said processor is configured to:
determine if the power level required for UE PUSCH transmission of PUSCH signals by the first UE is above a predetermined power level threshold; and
select non-SBFD resources to be used by the first UE for PUSCH signaling in response to determining that the power level required for UE PUSCH transmission of PUSCH signals is over the predetermined power level threshold,
as part of being configured to select resources to be used.

15. The base station of claim 11, wherein said processor is configured to select resources to be used by the first UE for PUSCH signaling by selecting between use of SBFD resources and non-SBFD resources based on the resource type of a received signal whose received power is used to control the transmit power level to be used for UE PUSCH transmission by the first UE;
wherein the received signal whose received power is used to control the transmit power level to be used for UE PUSCH transmission by the first UE is said received PRACH signal from the first UE; and
wherein said processor is configured to select SBFD resources in response to the PRACH signal from the first UE being received on SBFD resources, as part of being configured to select resources to be used by the first UE for PUSCH signaling.

16. A method of operating a base station, the method comprising:
receiving a physical random access channel (PRACH) signal from a first user equipment (UE);
sending a random access response (RAR) message to the first UE indicating resources to be used by the first UE for transmitting a PUSCH signal, said resources being first type of resource, said first type of resource being one of i) a sub-band full duplex (SBFD) resource or ii) a non-SBFD resource;
failing to detect a physical uplink shared channel (PUSCH) signal from the first UE on the indicated resources to be used by the first UE for transmitting a PUSCH signal;
scheduling PUSCH re-transmission for the first UE on resources which are of a different type than the first type resources; and
sending PUSCH re-transmission scheduling information to the first UE.

17. The method of claim 16, wherein the PUSCH re-transmission scheduling information, which is sent to the UE is communicated via Downlink Control Information (DCI).

18. The method of claim 17, wherein the first type of resource is an SBFD resource and the second type resource is a non-SBFD resource.

19. The method of claim 16, wherein the first type resource is a non-SBFD resource and the second type resource is an SBFD resource.

20. The method of claim 16, further comprising:
calculating a PUSCH re-transmission power level and a number of PUSCH signal repetitions to be used by the UE as part of the scheduled PUSCH re-transmission.

21. The method of claim 20, wherein sending PUSCH re-transmission scheduling information to the first UE includes:
communicating the re-transmission information including information indicating resources to be used for re-transmission, transmission power level and the number of repetitions to be performed as part of the PUSCH re-transmission via Downlink Control Information (DCI) communicated to the first UE.

22. The method of claim 20, wherein calculating the PUSCH re-transmission power level included calculating a re-transmission power level that is different from a transmission power level that was to be used for the PUSCH signal that was not detected.

23. The method of claim 20, wherein calculating number of PUSCH signal repetitions to be used by the UE as part of the scheduled PUSCH re-transmission includes calculating a larger number of repetitions than was scheduled to be used by the first UE for the PUSCH transmission which failed to be detected by the base station.

24. The method of claim 20, wherein calculating the PUSCH re-transmission power level and number of repetitions to be used by the UE as part of the scheduled PUSCH re-transmission includes calculating a higher transmission power level and higher number of repetitions than was to be used for the PUSCH transmission that failed to be received.

25. The method of claim 24, further comprising:
operating the base station to successfully receive a PUSCH re-transmission from the UE communicated on resources corresponding to the scheduled PUSCH re-transmission.

26. A base station comprising:
a wireless receiver;
a wireless transmitter; and
a processor configured to control the base station to:
receive a physical random access channel (PRACH) signal from a first user equipment (UE);
send a random access response (RAR) message to the first UE indicating resources to be used by the first UE for transmitting a physical uplink shared channel (PUSCH) signal, said resources being first type of resource, said first type of resource being one of i) a sub-band full duplex (SBFD) resource or ii) a non-SBFD resource;
determine that an expected PUSCH signal from the first UE on the indicated resources to be used by the first UE for transmitting a PUSCH signal has not been detected;
schedule PUSCH re-transmission for the first UE on resources which are of a different type than the first type resources; and
send PUSCH re-transmission scheduling information to the first UE.

27. The base station of claim 26, wherein the PUSCH re-transmission scheduling information, which is sent to the UE is communicated via Downlink Control Information (DCI).

28. The base station of claim 27, wherein the first type of resource is an SBFD resource and the second type resource is a non-SBFD resource.

29. The base station of claim 26, wherein the first type resource is a non-SBFD resource and the second type resource is an SBFD resource.

30. The base station of claim 26, wherein said processor is further configured to control the base station to:
calculate a PUSCH re-transmission power level and a number of PUSCH signal repetitions to be used by the UE as part of the scheduled PUSCH re-transmission.
